(19) United States
(12) Patent Application Publication
(10) Pub. No.: US 2011/0288738 A1
(43) Pub. Date: Nov. 24, 2011

(54) MULTI-FUEL VEHICLE STRATEGY

(75) Inventors: Frank Wegner Donnelly, North Vancouver (CA); David William Dewis, North Hampton, NH (US); Douglas W. Swartz, Lakewood, CO (US)

(73) Assignee: ICR TURBINE ENGINE CORPORATION, Hampton, NH (US)

(21) Appl. No.: 13/090,104

(22) Filed: Apr. 19, 2011

Related U.S. Application Data
(60) Provisional application No. 61/325,578, filed on Apr. 19, 2010.

(51) Int. Cl. F02D 28/00; G06F 19/00

(52) U.S. Cl. 701/99; 701/123

(57) ABSTRACT

The present invention discloses a method and enabling apparatus for integrating a new fuel or fuels into an operating transportation system in a continuous, seamless manner. The method disclosed overcomes the economic risk associated with developing a new fuel when there is little or no fuel distribution infrastructure in place for the new fuel.

Integrating a new fuel into an existing transportation system can be implemented with two enabling technologies. The first is an engine capable of operating seamlessly on multiple fuels. The second is a system of determining a driving strategy that makes the transition from one fuel to another seamless to the driver. A compact, high-performance gas turbine engine is an enabling apparatus of the above strategy. The system of driving strategy disclosed herein allows the operator of the vehicle or the fleet manager to minimize operational costs by estimating the best combination of fuels, fuel dispensers and driving strategies. By carrying at least one readily available fuel, the operator is free of infrastructure shortcomings for other fuels that may be less expensive or have superior emissions characteristics. The vehicle operator can therefore efficiently manage the use of on-board fuels as well as efficiently manage the driving schedule and route to achieve the lowest overall operating costs.

### CROSS REFERENCE TO RELATED APPLICATION

The present application claims the benefits, under 35 U.S.C.§119(e), of U.S. Provisional Application Ser. No. 61/325,578 entitled “Multi-Fuel Vehicle Strategy”, filed Apr. 19, 2010, which is incorporated herein by reference.

### FIELD

The present invention relates generally to fueling optimization strategies for vehicles capable of operating on several fuels. BACKGROUND

Multi-fuel vehicles are known. For example, cars with spark-ignited engines (Otto cycle) have been outfitted with natural gas and propane fuel capability so that they can run on gasoline, or they can switch and run on either natural gas or propane. These engines can be switched on the fly (that is when the engine is running and the vehicle is in motion). There is, however, a limitation on this multi-fuel capability since the fuels must have comparable ignition characteristics. The fuels must have a high enough octane rating such that they are ignited as prescribed by the spark ignition system not pre-ignited such as by compression or hot surfaces before the prescribed spark ignition.

Some trucks are available with diesel engines (Diesel cycle) and can run on diesel fuel or a mixture of diesel and natural gas. In the latter case, the natural gas is the predominant fuel and diesel is utilized as an ignition fuel. The fuels must have a high enough cetane number such that they are ignited by compression at the prescribed time of the combustion cycle.

Some fuels, such as gasoline and diesel, are widely available for use in vehicles through a well-developed distribution infrastructure. These fuels are well characterized in terms of ignition characteristics, cost, energy content and emissions. Other fuels, such as natural gas, bio-diesel, ethanol, methanol, butanol and hydrogen, are less readily available for use in vehicles but may have cost and emissions advantages over the widely available fuels.

For example, there is a distribution infrastructure for natural gas although this infrastructure is less developed for vehicles than for distribution to fixed commercial users. Both liquified natural gas (“LNG”) and compressed natural gas (“CNG”) forms of natural gas are available to vehicles as fuels on a limited basis. Refueling a natural gas-powered vehicle is often problematic since it requires special equipment and special procedures, which are not always convenient for vehicle operators.

There is currently a very limited infrastructure for hydrogen. However, if hydrogen fuels were available, they would have excellent emissions characteristics (no greenhouse carbon emissions at the point of use). As with natural gas, refueling would require special equipment and special procedures, which may not be convenient for vehicle operators.

The problem faced by developers of any new fuel is that they require a widely available distribution infrastructure for a new fuel to become accepted. However, the costs and risks of installing such an infrastructure are too great unless acceptance of the new fuel can be demonstrated. In addition, the introduction of a new fuel will cause inconvenience to vehicle operators if the new fuel requires new procedures, new equipment or is not readily available.

There therefore remains a need for innovative strategies for introducing new fuels for vehicles that can operate on any of several fuels where such introduction does not depend on a pre-existing well-developed distribution infrastructure and where such introduction can be made seamless to the vehicle operator.

### SUMMARY

These and other needs are addressed by the various embodiments and configurations of the present invention which are directed generally to a multi-fuel strategy for vehicles utilizing gas turbine engines.

In an embodiment, ses a method and enabling apparatus are disclosed for integrating a new fuel into an operating transportation system in a continuous, seamless manner. This method is illustrated by diesel fuel being gradually replaced by compressed natural gas (“CNG”) in long haul trucks. As can be appreciated, this same approach can be used for diesel and LNG as well as other fuels as they are developed, characterized, mass produced and eventually distributed. The method described herein overcomes the risk associated with developing a new fuel when there is little or no fuel distribution infrastructure in place.

Integrating a new fuel into an existing transportation situation (for example, introducing CNG to a long haul truck fleet) can be implemented using at least two enabling technologies. The first is an engine system capable of operating seamlessly two or more fuels without regard to the ignition characteristics of the fuels. The second is a communications and computing system for implementing a fueling strategy that both optimizes fuel consumption, guides the selection of fuel based upon location, cost and emissions and allows the transition from one fuel to another to appear substantially seamless to the truck driver.

A compact, high-performance gas turbine engine is a particularly advantageous apparatus for the above strategy. The gas turbine engine can have an advantage over reciprocating internal combustion engines, such as, for example, diesel engines, in that it can typically burn a variety of fuels without regard for ignition characteristics and with little or no modification to the fuel injection system when switching from fuel to fuel. This is so because the combustion process of a gas turbine engine can be substantially continuous, requiring primarily a certain level of specific energy from its fuels and not requiring special ignition characteristics from its fuels. Therefore, gas turbine engines are well-suited for multi-fuel operation.

The system of fueling strategy disclosed herein can allow the operator of the vehicle, or the fleet manager to minimize operational costs and/or fuel consumption by estimating the best combination of fuels, fuel dispensing locations, and driving strategies. By carrying at least one readily available fuel (such as diesel or gasoline), the operator can be free of infrastructure shortcomings for other fuels that may be less expensive or have desirable emission characteristics. With the assistance of the system disclosed herein, the vehicle operator can therefore efficiently manage the use of on-board fuels as well as efficiently manage his driving schedule and route to continue to get a better or best available fuel at a better or best available price.

In one configuration, a method is disclosed comprising: determining, by a computer, a current spatial location of a vehicle, the vehicle having at least differing first and second fuels for a common engine of the vehicle;

determining, by the computer, at least one of fuel availability, fuel pricing information and routing information for one or more fuel dispensers within a determined range of the vehicle; and

based on the determined at least one of fuel availability, fuel pricing information and routing information, determining, by the computer, a fuel strategy involving at least one of the first and second fuels.

In another configuration, a system is disclosed comprising: a computer operable to:

determine a current spatial location of a vehicle, the vehicle having at least differing first and second fuels for a common engine of the vehicle;

determine at least one of fuel and pricing information for one or more fuel dispensers within a determined range of the vehicle; and

based on the determined at least one of fuel and pricing information, determine a fuel strategy involving at least one of the first and second fuels.

In another configuration, a method and system are disclosed for:

determining, by a computer, a current spatial location of a vehicle comprising a fuel;

determining, by the computer, a plurality of fuel dispensers within a determined range of the current vehicle location; for each fuel dispenser,

determining, by the computer, at least one of a price for the fuel, a fuel consumption, and a cost to drive to the respective fuel dispenser from the current vehicle location; and

presenting, by a computer and to the operator, at least one of the fuel price, the fuel consumption, the driving cost, a recommendation of a fuel dispenser of the plurality of fuel dispensers, and a ranking of at least some of the plurality of fuel dispensers.

In another configuration, a vehicle is disclosed comprising:

a first fuel in a first fuel tank, the first fuel having an octane rating ranging from about 60 to about 120;

a first fuel in a first fuel tank, the first fuel having a specific energy, expressed as a low heat value, ranging from about 10 million joules per kilogram to about 60 million joules per kilogram;

a second fuel in a second fuel tank, the second fuel having a cetane number from about 10 to about 100;

a second fuel in a second fuel tank, the second fuel having a specific energy, expressed as a low heat value, ranging from about 10 million joules per kilogram to about 60 million joules per kilogram; and

one of a turbine and microturbine engine; and a fuel injection system operable to provide selectively to the engine the first fuel in the substantial absence of the second fuel, the second fuel in the substantial absence of the first fuel, and a mixture of the first and second fuels.

In another configuration, a vehicle is disclosed comprising:

a first fuel in a first fuel tank;

a second fuel in a second fuel tank, the first and second fuels having differing compositions;

one of a turbine and microturbine engine; and

a fuel injection system operable to provide selectively to the engine the first fuel in the substantial absence of the second fuel, the second fuel in the substantial absence of the first fuel, and a mixture of the first and second fuels. At least one of the following is true:

(a) a volume of the second fuel tank to the volume of the first fuel tank is in the range of from about 0.3:1 to about 1:1; and

(b) an available fuel energy of the first fuel in the first fuel tank to the second fuel in the second fuel tank is in the range of from about 2.5:1 to about 10:1.

In another configuration, a method and system are disclosed for:

providing a vehicle, the vehicle carrying first and second fuels, the first fuel being commonly available and the second fuel not being as commonly available as the first fuel and wherein a fuel injection system can provide selectively to a common engine at least one of a selected one of the first and second fuels and a selected combination of the first and second fuels;

determining, by a processor-executable on-board satellite positioning module, a current spatial location of the vehicle;

determining, by the processor, at least one of fuel and pricing information for one or more fuel dispensers within a determined range of the vehicle; and

based on the determined at least one of fuel and pricing information, determining, by the processor, a fuel strategy involving at least one of the first and second fuels.

In another configuration, a system is disclosed comprising a processor operable to:

determine a current spatial location of the vehicle, the vehicle comprising a commonly available first fuel and a less commonly available second fuel,

a common engine,

a fuel injection system to provide selectively to the engine a selected one of the first and second fuels; and

a processor operable to:
determine at least one of fuel and pricing information for one or more fuel dispensers within a determined range of the vehicle; and
based on the determined at least one of fuel and pricing information, determine a fuel strategy involving at least one of the first and second fuels.

In yet another configuration, a method is disclosed comprising:

providing a vehicle, the vehicle carrying first and second fuels, the first fuel being commonly available and the second fuel not being as commonly available as the first fuel and wherein a fuel injection system can provide selectively to a common engine at least one of a selected one of the first and second fuels and a selected combination of the first and second fuels without regard to the cetane number or octane rating of the first and second fuels or a selected combination of the first and second fuels.

These and other advantages will be apparent from the disclosure of the invention(s) contained herein.

The above-described embodiments and configurations are neither complete nor exhaustive. As will be appreciated, other embodiments of the invention are possible utilizing, alone or in combination, one or more of the features set forth above or described in detail below.

The following definitions are used herein:

The terms “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The following definitions are used herein:

Automatic and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The cetane number is a measure of the ignition quality of a fuel and it is an indication of ease of self-ignition commonly in a Diesel combustion cycle. The higher the cetane number, the more easily the fuel is ignited under compression. It is a measure of a fuel's ignition delay; the time period between the start of injection and start of combustion (ignition) of the fuel. In a particular diesel engine, higher cetane fuels will have shorter ignition delay periods than lower cetane fuels. Cetane numbers are typically used for relatively light distillate diesel fuels. The cetane number was originally a minimum of 45-49 in 1993, was raised to 51 in 2000 to reduce ignition delay, improve combustion and reduce exhaust emissions. The introduction of electronically controlled injection allows a stepwise high-pressure injection of the fuel into the combustion chamber. This makes direct fuel injection sufficiently smooth and offers additional reductions of emissions so that the highly efficient direct-injection diesel engines are suitable for passenger cars, and they have since replaced the previously used swirl and pre-chamber engines. However, low emissions and smooth engine running can only be achieved with high-quality fuels and recent tests have shown that synthetic diesel fuels with ultra-high cetane numbers can reduce emissions further.

CNG means Compressed Natural Gas.

Computer-readable medium as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the invention is considered to include a tangible storage medium or distribution medium and prior art-recognized equivalents and successor media, in which the software implementations of the present invention are stored.

Determine, calculate and compute and variations thereof, as used herein, are used interchangeably and include any type of methodology, process, mathematical operation or technique.

A DGE or Diesel Gallon Equivalent is a measure of the volume of a fuel with an energy equivalent to the energy of 1 gallon of diesel fuel on a low heat value basis.

A driving strategy as used herein refers to vehicles capable of operating on two or more fuels and is a strategy for minimizing vehicle operating costs by assimilating knowledge on fuel costs, fuel consumption, fueling station locations, driving routes, driving terrain and driving restrictions (if any) and driving times and using this knowledge to pick a fueling location that minimizes overall vehicle operating costs and/or fuel consumption, respecting cost of various fuels, the driver's time and the types of routes to the various possible fueling stations.

Energy density as used herein is energy per unit volume (joules per cubic meter).

An energy storage system refers to any apparatus that acquires, stores and distributes mechanical, chemical or electrical energy which is produced from another energy source such as a prime energy source, a regenerative braking system, a catenary or any external source of electrical energy. Examples are a battery pack, a bank of capacitors, a pumped storage facility, a compressed air storage system, an array of a heat storage blocks, a bank of flywheels, a fuel reformer, an electrolysis apparatus or a combination of storage systems.

An engine is a prime mover and refers to any device that uses energy to develop mechanical power, such as motion in some other machine. Examples are diesel engines, gas or steam turbine engines, microturbines, Stirling engines, steam engines and spark ignition engines

A gas turbine engine as used herein may also be referred to as a turbine engine or microturbine engine. A microturbine is commonly a sub category under the class of prime movers called gas turbines and is typically a gas turbine with an output power in the approximate range of about a few kilowatts to about 700 kilowatts. A turbine or gas turbine engine is commonly used to describe engines with output power in the range above about 700 kilowatts. As can be appreciated, a gas turbine engine can be a microturbine since the engines may be similar in architecture but differing in output power level. The power level at which a microturbine becomes a turbine engine is arbitrary and the distinction has no meaning as used herein.

A GGE or Gasoline Gallon Equivalent is a measure of the volume of a fuel with an energy equivalent to the energy of 1 gallon of gasoline fuel on a low heat value basis.

An ignition characteristic of a fuel refers to a chemical or physical property of the fuel that influences the condition under which the timing and intensity of burning occurs. In reciprocating engines, the timing of fuel ignition is typically desired in a narrow range of the combustion cycle, typically as the peak compression point is approached. Optimum ignition may be determined by performance or emissions requirements or both. For fuels used in reciprocating engines, there are many additives that may be used to modify ignition characteristics. In diesel engines, the cetane number relates to the fuels ease of self-ignition during compression. In a spark-ignition engines, the octane rating is a measure of the resistance of the fuel to auto-ignition during compression.

LHV means Low Heat Value and is the specific energy content (sometimes called the heat of combustion) of a fuel obtained from combusting the fuel wherein the water in the exhaust remains in the form of vapor. The High Heat Value (HHV) is based on the water in the exhaust being in liquid form. Since water vapor gives up heat energy when it changes from vapor to liquid, the HHV value is larger than the LHV of the fuel since it includes the latent heat of vaporization of water. The difference between the high and low values is significant and can be as much as about 10%.

LNG means Liquified Natural Gas. Natural gas becomes a liquid when cooled to a temperature of about 175 K or lower. LNG is predominantly methane, typically 90% or more methane, that has been converted temporarily to liquid form for ease of storage or transport. LNG takes up about 1/600th the volume of natural gas in the gaseous state. In a typical LNG process, natural gas is transported to a processing plant where it is purified. The gas is then cooled down in stages until it is liquefied at close to atmospheric pressure (maximum transport pressure set at around 25 kPa) by cooling it to approximately 175 K (−162 ° C.). The reduction in volume makes it much more cost efficient to transport over long distances in specially designed cryogenic sea vessels (LNG carriers) or cryogenic road tankers. The energy density of LNG is 60% of that of diesel fuel on a low heat value (LHV) basis. The density of LNG is roughly 41 kg/cu m to 50 kg/cu m, depending on temperature, pressure and composition. The heat value depends on the source of gas that is used and the process that is used to liquefy the gas. The higher heating value of LNG is estimated to be 24 MEL at −164 degrees Celsius. This value corresponds to a lower heating value of 21 MJ/L.

Octane rating is a measure of the resistance of gasoline and other fuels to auto-ignition in spark-ignition internal combustion engines. The octane number of a fuel is measured in a test engine, and is defined by comparison with the mixture of iso-octane and heptane which would have the same anti-knocking capacity as the fuel under test: the percentage, by volume, of iso-octane in that mixture is the octane number of the fuel. For example, petrol with the same knocking characteristics as a mixture of 90% iso-octane and 10% heptane would have an octane rating of 90. This does not mean that the petrol contains just iso-octane and heptane in these proportions, but that it has the same detonation resistance properties. Because some fuels are more knock-resistant than iso-octane, the definition has been extended to allow for octane numbers higher than 100. Octane rating does not relate to the energy content (heating value) of the fuel. It is only a measure of the fuel's tendency to burn in a controlled manner, rather than exploding in an uncontrolled manner. Where octane is raised by blending in ethanol, energy content per volume is reduced.

A permanent magnet motor is a synchronous rotating electric machine where the stator is a multi-phase stator like that of an induction motor and the rotor has surface-mounted permanent magnets. In this respect, the permanent magnet synchronous motor is equivalent to an induction motor where the air gap magnetic field is produced by a permanent magnet. The use of a permanent magnet to generate a substantial air gap magnetic flux makes it possible to design highly efficient motors. In the example of a common 3-phase permanent magnet synchronous motor, a standard 3-phase power stage is used. The power stage utilizes six power transistors with independent switching. The power transistors are switched in ways to allow the motor to generate power, to be free-wheeling or to act as a generator by controlling frequency.

A prime power source refers to any device that uses energy to develop mechanical or electrical power, such as motion in some other machine. Examples are diesel engines, gas turbine engines, microturbines, Stirling engines, spark ignition engines and fuel cells.

A power control apparatus refers to an electrical apparatus that regulates, modulates or modifies AC or DC electrical power. Examples are an inverter, a chopper circuit, a boost circuit, a buck circuit or a buck/boost circuit.

Power density as used herein is power per unit volume (watts per cubic meter).

A recuperator as used herein is a gas-to-gas heat exchanger dedicated to returning exhaust heat energy from a process back into the pre-combustion process to increase process efficiency. In a gas turbine thermodynamic cycle, heat energy is transferred from the turbine discharge to the combustor inlet gas stream, thereby reducing heating required by fuel to achieve a requisite firing temperature.

A report producing device as used herein is any device or collection of devices adapted to automatically and/or mechanically produce a report. As one example, a report producing device may include a general processing unit and memory (likely residing on a personal computer, laptop, server, or the like) that is adapted to generate a report in electronic format. The report producing device may also comprise a printer that is capable of generating a paper report based on an electronic version of a report.

Shorepower is a term used in the trucking business utilizing a combination of truck-board and facility power systems. This is sometimes referred to as shorepower since the hardware aboard the sleeper cab and at the parking facility is similar to that found at boat marinas.

Specific energy as used herein is energy per unit mass (joules per kilogram).

Specific power as used herein is power per unit mass (watts per kilogram).

A switched reluctance motor is a type of synchronous electric motor that induces non-permanent magnetic poles on the ferromagnetic rotor. Torque is generated through the phenomenon of magnetic reluctance. A switched reluctance motor may be known as a synchronous reluctance motor, variable reluctance motor, reluctance motor or variable reluctance stepping motor. Reluctance motors can have very high power density at low-cost, making them ideal for many applications. Disadvantages are high torque ripple when operated at low speed, and noise caused by torque ripple. Until recently, their use has been limited by the complexity inherent in both designing the motors and controlling them. These challenges are being overcome by advances in the theory, by the use of sophisticated computer design tools, and by the use of low-cost embedded systems for motor control. These control systems are typically based on microcontrollers using control algorithms and real-time computing to tailor drive waveforms according to rotor position and current or voltage feedback. The switched reluctance motor (SRM) is a form of stepper motor that uses fewer poles than a synchronous reluctance motor. The SRM can have the lowest construction cost of any industrial electric motor because of its simple structure. Common usages for an SRM include applications where the rotor must be held stationary for long periods and in potentially explosive environments such as mining because it lacks a mechanical commutator. The phase windings in a SRM are electrically isolated from each other, resulting in higher fault tolerance compared to inverter driven AC induction motors. The optimal drive waveform is not a pure sinusoid, due to the non-linear torque relative to rotor displacement, and the highly position dependent inductance of the stator phase windings.

### BRIEF DESCRIPTION OF THE DRAWINGS

FIG. 1 is a line drawing of a gas turbine suitable for long haul trucks. This is prior art.

FIG. 2 is a line drawing of a gas turbine installed in a long-haul truck chassis and is compared to a diesel engine mounted in the same vehicle frame. This is prior art.

FIG. 3 is a schematic of a truck with a second fuel tank on the cab.

FIG. 4 is a schematic of a truck with a second fuel tank in the trailer.

FIG. 5 is a schematic of a truck with fuel tanks in various locations.

FIG. 6 is a schematic of a truck with several fuel tanks

FIG. 7 is a schematic of an example multi-fuel fueling station

FIG. 8 is a schematic of a CNG fuel dispensing system.

FIG. 9 shows typical annual price variation of diesel and natural gas fuels.

FIG. 10 shows typical variation of price as a function of station size.

FIG. 11 shows breakeven cost for use of a lower price alternate fuel.

FIG. 12 is a schematic representation of a network-based system for optimizing fuel consumption and driving strategy for a multi-fuel vehicle.

FIG. 13 is a flow chart illustrating an operational embodiment of the system of FIG. 12.

### DETAILED DESCRIPTION

Introduction of a New Fuel into an Operating Transportation System

The following is an example of how a new fuel can be integrated into an operating transportation system in a continuous, seamless manner. This example shows how diesel can be gradually be replaced by compressed natural gas (“CNG”) in long haul trucks. As can be appreciated, this same approach can be used for other fuels as they are developed, characterized, mass produced and eventually distributed. The approach described herein overcomes the economic and investment risks associated with developing a new fuel when there is little or no distribution infrastructure in place for the new fuel.

### Example of Replacing Diesel with CNG

Natural gas has been recognized as a practical replacement for diesel fuel in terms of availability, cost and reduction of greenhouse gas emissions. It appears that all other alternatives for transportation fuels have as-yet unsolved social, economic and commercial consequences. These consequences include their impact on world food prices, uncompetitive costs, extensive land usage and often limited availability. Natural gas can be used as a fuel either as compressed natural gas (“CNG”) or liquified natural gas (“LNG”).

As a replacement for diesel fuel in over-the-road Class 8 trucks, LNG has been thought to be the most commercially viable form of natural gas because of its relatively high energy density compared to CNG. Thus, LNG is believed to be necessary to enable efficient transportation over long distances. But in terms of costs, LNG as a fuel appears to be only marginally lower in cost than diesel fuel. This impacts the commercial risk of a trucking operator especially when an expensive truck is dedicated to operate only on LNG. To mitigate this disincentive, various levels of governments world-wide have instituted programs with economic inducements (subsidies) to encourage the adoption natural gas as a truck fuel.

The cost of LNG is generally higher than that of CNG because LNG requires significantly more energy to liquify the natural gas to a cryogenic fluid than to compress CNG to its most practical storage pressure. Heretofore, natural gas has been much more abundant and available at a lower cost outside of North America. Thus, in the past, for natural gas to be practical as a widely used fuel, it would have to come from overseas, typically in the form of LNG because of the large distances over which it must be shipped. CNG however has become attractive, especially for North America, because of the recent application of horizontal drilling and hydraulic fracturing technologies to open up vast new sources of natural gas (often referred to as shale gas), which reduces the economic attractiveness of the more costly LNG from overseas.

An objective of this invention is to enable the adoption of natural gas as a transportation fuel for sound, sensible business reasons that will not require the same level of subsidy, if it needs to be subsidized at all. This method of introducing new fuels is expandable to other fuels such as bio-diesel, for example, once the large-scale production problems of such fuels are solved.

A primary reason that negatively impacts the business case for the adoption of LNG as a replacement for diesel fuel, especially in long-haul trucking, besides the obvious lack of fueling infrastructure, is the cost of LNG and the limitations and consequences of owning and operating an LNG truck. When comparing the commodity feedstocks of LNG (natural gas) and diesel fuel (crude oil), the price comparison between the commodities on an energy basis is generally quite different, with natural gas being, on average, substantially below the cost of crude oil. However when comparing the delivered finished products LNG and diesel fuel, the costs are very comparable. This raises an important question for the owner-operator of the advantages of converting solely to LNG. Do the needs of special handling and servicing, and of higher cost of ownership justify the transition to LNG from a more widely used fuel such as diesel?

The reason for the significant difference between the commodity cost of natural gas and the delivered cost of LNG is the capital cost of all of the equipment, the regional liquefier plants, the on-highway delivery tanker truck fleet, and the on-site LNG fuel storage and dispensing, and additionally the high operating costs. The operating costs are the energy costs for the energy-intensive liquefaction process, the plant operating and maintenance costs, and the cost of operating the LNG distribution system. The high costs incurred in setting up an LNG production business are a barrier for smaller firms that could provide competition and thereby help lower LNG costs. LNG is required by natural gas-powered vehicles for range purposes. With the approach of the present invention, this need no longer be a constraint.

The other form of natural gas used as a vehicle fuel is CNG. CNG is significantly cheaper than LNG and has the potential to provide the necessary, non-subsidized economic justification to use CNG as a replacement for diesel fuel for over-the-road trucking The reason that CNG has lower delivery cost is that in can be produced on-site, at a truck stop, with the existing natural gas distribution system. That is, CNG as a delivered fuel, requires substantially lower capital and operating costs for its distribution infrastructure than LNG.

The primary argument against the use of CNG, especially for long distance trucking, is that it limits the operating range of a truck because CNG is a gaseous fuel with a relatively low energy density. Thus, the argument is that CNG tanks take up too much space and/or not enough fuel can be carried on-board. As the thinking goes, LNG is preferable for extended range operations because of its higher energy density and therefore the ability to get more fuel on board the truck's limited space. Thus, LNG is often thought to be the most practical way to introduce natural gas as a substitute for diesel fuel.

The present invention can offer a solution to the range limitation of CNG so that the truck operator is not adversely affected or inconvenienced. At the same time, the operator is able to reduce the operating costs of the truck without the need for subsidies.

An enabling technology for the adoption of CNG as a replacement of diesel fuel in over-the-road trucks is a practical gas turbine truck engine that can use different types of fuels and change fuels on the fly in a seamless fashion. Thus, fuel selection can become a discretionary decision based on cost and/or fuel consumption as well as availability. Therefore, if a truck that is powered with a gas turbine engine and has a sufficiently large liquid fuel tank (for liquid fuels such as diesel or gasoline for example) for an acceptable operating range, the CNG storage capacity (operational range on CNG) is not critical to the truck's economical operation. If the truck is not dependent on CNG for its operation, then it may be operated beyond the range of CNG fueling infrastructure and the sizing of the CNG storage can be determined based on practical and economic considerations other than range.

A CNG fueled truck that does not totally depend on CNG, will be a boon for the effort to adopt natural gas as a substitute for diesel fuel on the interstates highway system because it gets around the conundrum of (1) attracting customers for CNG before a CNG fueling infrastructure is available and (2) financing a CNG fueling infrastructure before a customer base is established.

As noted previously, an important aspect for the successful implementation of CNG as a truck fuel is the rational sizing of the CNG storage capacity based on with practical and economic considerations. CNG storage on a truck is relatively bulky and expensive compared to standard diesel fuel tanks on a diesel gallon equivalent (DGE) basis. CNG cylinders that can store natural gas at about 3,600 psi occupy about 4 times the volume of a diesel fuel tank having the same operating range. CNG cylinders that can store natural gas at about 4,200 psi occupy about 3.5 times the volume of a diesel fuel tank having the same operating range. In addition, CNG tanks currently cost several times the cost of diesel fuel tanks and can add significant weight as well as volume to the fuel storage system.

What first becomes apparent is that the CNG fuel storage needs to fit on the truck's tractor or trailer chassis while retaining the standard, or at least, an acceptable amount of diesel fuel storage on board. Secondly, a reasonable amount of CNG storage needs to be considered because of cost and/or fuel consumption. Carrying any more CNG that is needed for the minimum amount of acceptable convenience, adversely affects the operating economics of the truck. Having too little CNG storage on board is also counterproductive as the driver will need to refill the CNG tanks more often than usual, resulting in the driver wasting time that will adversely affect schedule.

Sizing the CNG fuel tanks so that under normal driving conditions, refilling would coincide with the driver's need for breaks appears to be practical. Thus, if the driver goes about 4 hours between breaks (meals) and covers about 250 miles during that period and is getting about 6.5 miles per gallon, the operator will need at least 38 DGE of CNG on board to cover that distance with natural gas (250 miles/6.5 miles per gallon=38.5 gallons). Returning to the physical layout of the truck tractor or trailer, space for about 40 to 50 DGE of CNG storage appears to be available without compromising the operation and safety of the vehicle.

By way of illustration, for the above case of an approximately 4 hour driving range on CNG, the volumetric ratio of CNG storage compared to liquid fuel storage volume is typically in the range of from about 0.3:1 to about 1:1, and even more typically in the range of from about 0.4:1 to about 0.8:1. Stated another way, the available fuel energy ratio of stored liquid fuel to stored CNG is typically in the range of from about 2.5:1 to about 10:1, and even more typically in the range of from about 4:1 to about 8:1.

By way of further illustration, for the above case of approximately equal driving ranges, the volumetric ratio of CNG storage compared to liquid fuel storage volume is typically in the range of from about 1:1 to about 6:1, and even more typically in the range of from about 3:1 to about 5:1.

### Example of Refueling Procedure to Accommodate New Fuel

Refueling a truck more than 1 or 2 times per day could take an hour out of the driver's day. This could be considered an inconvenience especially if the driver is used to an operating range that the typical 300 gallon diesel fuel tank yields between refueling. The present invention proposes a method for substantially minimizing this time-consuming inconvenience of periodic re-fillings of a limited capacity CNG fuel tank.

When the driver takes a break from driving, the driver often stops at a large truck stop. Here the driver can park his truck in a designated spot. If this spot is equipped with a CNG dispenser or a CNG filling post, the driver can connect his truck to a source of CNG in seconds, go about business, return, disconnect his re-fueled truck from the CNG dispenser, again in seconds, and drive off. This entire procedure would be virtually the same as his normal routine and he will have refueled the truck with CNG in the process. As can be appreciated, the recording and purchasing of the CNG can all be handled electronically.

The gas turbine engine can have an advantage over other types of internal combustion engines, such as for example diesel engines, in that they can typically burn a variety of fuels without regard for ignition characteristics and with little or no modification to the fuel injection system. Gas turbines are substantially insensitive to the ignition characteristics of fuels and can operate on fuels having a wide range of specific energy values. This is principally because the combustion process in a gas turbine engine is substantially continuous. The combustion process in a reciprocating engine is cyclical and requires ignition of new fuel introduced during each cycle. Therefore, gas turbine engines are well-suited for multi-fuel operation. For example, a vehicle utilizing a gas turbine engine may be operated on either diesel fuel which is widely available for vehicles, or on CNG or LNG (the latter two being less widely available for vehicles) simply by selecting the fuel delivery system. For example, gas turbines can be fitted with injectors that permit both gaseous and liquid fuels to be used. The vehicle can be outfitted with a diesel fuel tank and a CNG or LNG fuel tank.

In one vehicle design, the vehicle has multiple on-board stored fuel receptacles, each receptacle including a different type of gaseous or liquid fuel. For example, a first fuel can be diesel fuel, and a second fuel can be CNG. In a further example, the first fuel can be a renewable or a nonrenewable fuel while the second fuel can also be a renewable or a nonrenewable fuel. The vehicle has a prime mover, such as a gas turbine engine, that is substantially independent of one or more of the fuel additives required by reciprocating engines. By way of illustration, such additives may include for example, anti-oxidants, metal de-activators, and anti-stall agents, and other antiknock chemicals for gasolines and cold-flow improvers, wax anti-settling additives, detergents, anti-corrosion, anti-wear additives and anti-foam additives for diesel fuels.

An innovative feature of this system is that the change from one fuel to another can be made on the fly, even if one fuel is a liquid (diesel in this example) and one is gaseous (CNG in this example). Unlike other dual fuel (diesel/natural gas) truck engine technology, a gas turbine engine can replace commonly at least about 75%, more commonly at least about 80%, more commonly at least about 85%, more commonly at least about 90%, more commonly at least about 95%, and even more commonly about 100% of the diesel fuel with natural gas. This is so because the piston dual fuel engine needs to retain a portion of its diesel fuel for a pilot ignition source for the natural gas.

If, for example, natural gas is the more desirable fuel from either or all of a cost standpoint, a fuel consumption standpoint or an emissions standpoint, then it would be preferable to operate the vehicle on natural gas as long as natural gas were readily available. If the vehicle could not be readily refueled with natural gas, it could be switched to operate on diesel, which is less desirable but almost universally available. It is also noted that a gas turbine engine can be configured to operate on a mixture of liquid and gaseous fuels and/or even on a mixture of liquid fuels such as, for example, a mixture of gasoline and diesel. With the present invention it may also be possible to achieve a net reduction of emissions by selecting a ratio of natural gas to diesel, allowing the engine to be operated in a minimum emissions mode. The accelerated flame of the diesel fuel in a diesel/natural gas mix may have beneficial effects in the design of the gas turbine combustor.

Another aspect of the present invention is that refueling episodes for the less widely available fuels may be designed to resemble the refueling episodes for the more widely available fuels so that vehicle operators will choose a fuel based on cost, fuel consumption or emissions criteria or any combination of the three, and not on the convenience of the fuel dispensing system to which they are accustomed.

As an example of this, a vehicle can be parked and slow-filled with CNG while the operator uses the store/restaurant facility. In slow-fill, the CNG is pressurized from a lower pressure to the maximum pressure of the vehicle's CNG gas storage cylinders (typically about 3,600 psia or about 25 kPa). This method of filling uses a minimum of energy for gas compression and permits more fuel to be stored due to the more accurate reading of tank pressure and temperature during the fill, thus optimizing tank fill by measuring pressure and temperature and using this information to modulate the flow. This is in contrast to rapid filling (which is more convenient and mimics filling with diesel or gasoline, where the operator does the filling and then moves on) wherein the CNG is expanded from a higher pressure source down to the maximum pressure of the vehicle's CNG storage cylinders. This method of filling uses more energy for compression to the higher pressure storage tanks, typically about 20% to about 25% more energy, and this is reflected as an increased fuel price (typically about 10 to about 12 cents of every dollar).

The above discussion of integrating a new fuel into an existing transportation situation (such as the above example of introducing CNG to a long haul truck fleet) can be implemented with at least two enabling technologies. The first is an engine capable of operating seamlessly on multiple fuels. The second is a system of determining a fueling strategy that reduces overall operational costs (including fuel consumption) and makes the transition from one fuel to another seamless to the truck driver.

### Electrification Stations

Truck engine idling is increasingly recognized as an aesthetic and environmental problem across the United States. Truck Stop Electrification (TSE) is an approach currently being deployed to reduce heavy truck idling at truck stops and rest areas. Drivers of the nearly 500,000 long-haul trucks in the United States must rest for specific periods as prescribed by U.S. Department of Transportation regulations. Long-haul truck drivers typically idle their engines to heat or cool sleeper cab compartments, and to maintain vehicle battery charge while electrical appliances such as televisions and microwaves are in use. In colder climates, idling also keeps engine oil and fuel warm enough to prevent engine starting and operating problems. The average sleeper cab tractor idles for 1,830 hours annually, and consumes approximately one gallon of diesel fuel per hour. However, idling increases fuel and maintenance costs, emissions, and noise.

Options to reduce idling include auxiliary power units and fuel-fired heaters. Both have significant operational, environmental or cost disadvantages compared to TSE. TSE is a preferred approach to anti-idling because of zero on-site air emissions and minimal noise emissions. Heavy truck engine idling can be virtually eliminated at TSE-equipped locations and thus can improve environmental conditions at truck parking areas and in the communities that surround them.

The combination use of truck-board and facility power systems is also frequently referred to as shorepower, since the hardware aboard the sleeper cab and at the parking facility is similar to that found at boat marinas. The shorepower system gives access to 120- or 240-Volt electrical power from a land-based electrical power source. This approach separates the electrical supply available at a parking facility from the accessory system installed in a tractor.

An electrified fueling station is prior art. A typical stationary shorepower infrastructure consists of 20 or more RV-style power pedestals. The pedestals may be equipped with AC electrical power, cable TV, Internet, and telephone service connections. Typically, one pedestal will be provided for each of the 20 or more parking spaces. A payment system or payment kiosk can be placed in each TSE parking space or can be placed centrally to the about 20 or more shorepower parking berths.

Truck stop electrification facilities are examples of truck stop facilities that provide long-standing services such as fueling, restrooms and restaurants while overcoming significant emissions, noise and aesthetic concerns without unnecessary inconvenience to vehicle operators.

### Liquid Natural Gas (LNG) Stations

Liquid Natural Gas (LNG) fueling stations are prior art. LNG fueling stations are currently used for fueling heavy and medium duty vehicles. The LNG fuel is produced at LNG plants from pipeline gas cooled to about −260F (about 110 K) and delivered in LNG trailers to fuel stations. These plants can produce typically about 160,000 to about 300,000 gallon per day and typically can store about 1.5 to about 2 million gallons of LNG on site.

There are currently two Grades of LNG. The first is Blue (Cold) LNG for Westport GX engines and the second is Green (Warm) LNG for spark-ignited engines. Blue LNG increases storage capacity and range and is optimized for Westport GX engines. Its advantages are increased truck range, increased fuel economy and elimination of venting losses. It is a colder fuel, stored in on-board tanks at about −225 F and about 35 psig. Green LNG is optimized for CWI ISL-G spark-ignited engines. It is stored in on-board tanks at about −195 to about −207 F and about 85 to about 120 psig.

LNG fueling pumps are prior art. These fueling pumps can dispense fuel at rates comparable to diesel or gasoline pumps. Fueling may be carried out by the vehicle operator. A typical LNG truck stop will accommodate about 25 to about 50 trucks per hour with about 10 dispensing lanes and with about 100,000 gallons of fuel storage on site.

### Compressed Natural Gas (CNG) Stations

Compressed Natural Gas (CNG) fueling stations are prior art. CNG fueling stations are currently used for fueling light, medium, and medium-heavy duty vehicles. Natural gas is delivered by pipeline to fueling station via the same distribution network used for gas that heats homes and is used for cooking The natural gas is compressed at the station to about 3,600 psi for dispensing and may be dispensed in a manner similar to gasoline or diesel. When dispensed in this manner, it is known as fast fueling. It is typically stored on the vehicle in one or more gas cylinders.

CNG stations typically dispense about 35 million DGEs of CNG annually, growing at about 10% per year. Compressed natural gas is the same fuel that is used in many homes and is delivered in a pipeline by the local utility. CNG is used at about 3,600 psi as a gaseous fuel and is thus different from LNG, which is cryogenic. It is sold in therms, Gasoline Gallon Equivalents (GGEs) or Diesel Gallon Equivalents (DGEs). On-board storage capacity is enough to provide sufficient range for regional trucking CNG meets clean truck program requirements, it is typically a low fuel price requiring on-site fuel storage. CNG is odorized for safety and there is no waste due to boil off.

There may be public and private fueling stations. A small private station may serve about a 50 truck fleet and dispense about 60,000 DGEs per month. A large private station may serve about a 200 truck fleet and dispense about 250,000 DGEs per month.

Typical commercial CNG dispensers are operated like a gasoline or diesel filling pump apparatus. This dispensing unit may be operated as a fast fueling pump where the vehicle operator may do the dispensing or it may be operated as a slow fueling pump where the vehicle operator can leave the vehicle to use a nearby rest stop, restaurant and store. As will be discussed below, the slow fueling method for CNG has a significant energy advantage over the fast fueling method for CNG and therefore the slow fueling method has a significant cost advantage as well. A typical commercial filling point that would be operated as a slow fueling pump where the vehicle operator can leave the vehicle parked for a substantial period (many minutes to a couple of hours).

One advantage of CNG as a fuel is that there already exists a natural gas distribution system in most countries. For example, a natural gas distribution network comprised of main natural gas distribution trunk lines and the smaller distribution pipelines exists in the United States and this network extends into Canada and Mexico. Currently, an LNG fuel station costs approximately 4 times more to install than a CNG fuel station.

### Exemplary Gas Turbine Engine

A gas turbine engine is an enabling engine for efficient multi-fuel use and, in particular, this engine can be configured to switch between fuels while the engine is running and the vehicle is in motion (on the fly). In addition, a gas turbine engine can be configured to switch on the fly between liquid and gaseous fuels or operate on combinations of these fuels. This is possible because combustion in a gas turbine engine is continuous (as opposed to episodic such as in a reciprocating piston engine) and the important fuel parameter is the specific energy content of the fuel (that is, energy per unit mass) not its cetane number or octane rating. The cetane number (typically for diesel fuels) or octane rating (typically for gasoline fuels) are important metrics in piston engines for specifying fuel ignition properties.

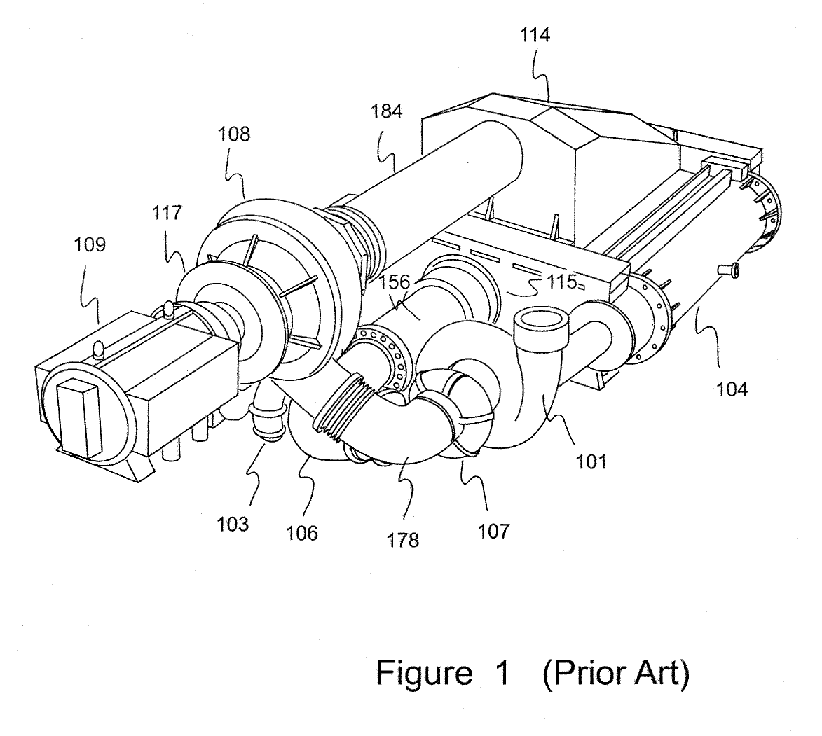

The gas turbine engine such as shown in FIG. 1 enables the fuel strategy of the present invention. This engine is prior art although efficient multi-fuel configurations will require innovative modifications. This is an example of a 375 kW engine that uses intercooling and recuperation to achieve high operating efficiencies (40% or more) over a substantial range of vehicle operating speeds. This compact engine is suitable for light to heavy trucks. Variations of this engine design are suitable for smaller vehicles as well as applications such as, for example, marine, rail, agricultural and power-generating. One of the principal features of this engine is its fuel flexibility and fuel tolerance. This engine can operate on any number of liquid fuels (gasoline, diesel, ethanol, methanol, butanol, alcohol, bio diesel and the like) and on any number of gaseous fuels (compressed or liquid natural gas, propane, hydrogen and the like). This engine may also be operated on a combination of fuels such as mixtures of gasoline and diesel or mixtures of diesel and natural gas. Switching between these fuels is generally a matter of switching fuel injection systems and/or fuel mixtures.

For example, at a first time a gas turbine engine burns a first fuel mixture, and at a second time a different second fuel mixture. The first and second mixtures include at least one uncommon fuel type. The first mixture, for instance, can have diesel as the primary fuel, and the second mixture CNG or LNG as the primary fuel. In another illustration, the first mixture, by way of further illustration, is a first mixture ratio of fuels A and B, and the second mixture a different second mixture ratio of fuels A and B. In all of the above illustrations, the specific energy of the first fuel mixture is commonly at least about 20%, more commonly at least about 50%, and even more commonly at least about 80% of the specific energy of the second fuel mixture. For example, a reciprocating engine typically burns fuels having a low heat value (LHV) in the range of about 40 million to about 55 million Joules per kilogram. A gas turbine engine can burn fuels having a low heat value (LHV) in the range of about 10 million to about 55 million Joules per kilogram.

Not only can a gas turbine burn fuels of lower specific energy, but they can burn less complex fuels as discussed below. This has the potential of reducing the costs of refining fuels by simplifying fuel requirements.

This engine operates on the Brayton cycle and, because combustion is continuous, the peak operating temperatures are substantially lower than comparable sized piston engines operating on either an Otto cycle or Diesel cycle. This lower peak operating temperature results in substantially less NOx emissions generated by the gas turbine engine shown in FIG. 1. This figure shows a load device 109, such as for example a high speed alternator, attached via a reducing gearbox 117 to the output shaft of a free power turbine 108. A cylindrical duct 184 delivers the exhaust from free power turbine 108 to a plenum 114 which channels exhaust through the hot side of recuperator 104. Low pressure compressor 101 receives its inlet air via a duct (not shown) and sends compressed inlet flow to an intercooler (also not shown). The flow from the intercooler is sent to high pressure compressor 103 which is partially visible underneath free power turbine 108. As described previously, the compressed flow from high pressure compressor 103 is sent to the cold side of recuperator 104 and then to a combustor which is contained inside recuperator 104. The flow from combustor 115 (whose outlet end is just visible) is delivered to high pressure turbine 106 via cylindrical duct 156. The flow from high pressure turbine 106 is directed through low pressure turbine 107. The expanded flow from low pressure turbine 107 is then delivered to free power turbine 108 via a cylindrical elbow 178.

This engine has a relatively flat efficiency curve over wide operating range. It also has a multi-fuel capability with the ability to change fuels on the fly as described in U.S. Provisional Application No. 61/325578 entitled “Multi-Fuel Vehicle Strategy”, filed on Apr. 19, 2010 and which is incorporated herein by reference.

For example, in a large Class 8 truck application, the ability to close couple turbomachinery components can lead to the following benefits. Parts of the engine can be modular so components can be positioned throughout vehicle. The low aspect ratio and low frontal area of components such as the spools, intercooler and recuperator facilitates aerodynamic styling. The turbocharger-like components have the advantage of being familiar to mechanics who do maintenance. It can also be appreciated that the modularity of the components leads to easier maintenance by increased access and module replacement. Strategies for replacement based on simple measurements filtered by algorithms can be used to optimize maintenance strategies. These strategies could be driven by cost, fuel consumption, emissions or efficiency. In a Class 8 truck chassis, the components can all be fitted between the main structural rails of the chassis so that the gas turbine engine occupies less space than a diesel engine of comparable power rating. This reduced size and installation flexibility facilitate retrofit and maintenance. This ability also permits the inclusion of an integrated APU on either or both of the low and high pressure spools such as described in U.S. Provisional Application No. 61/361,083, entitled “Improved Multi-Spool Intercooled Recuperated Gas Turbine”, filed Jul. 2, 2010 which is incorporated herein by reference. This ability also enables use of direct drive or hybrid drive transmission options.

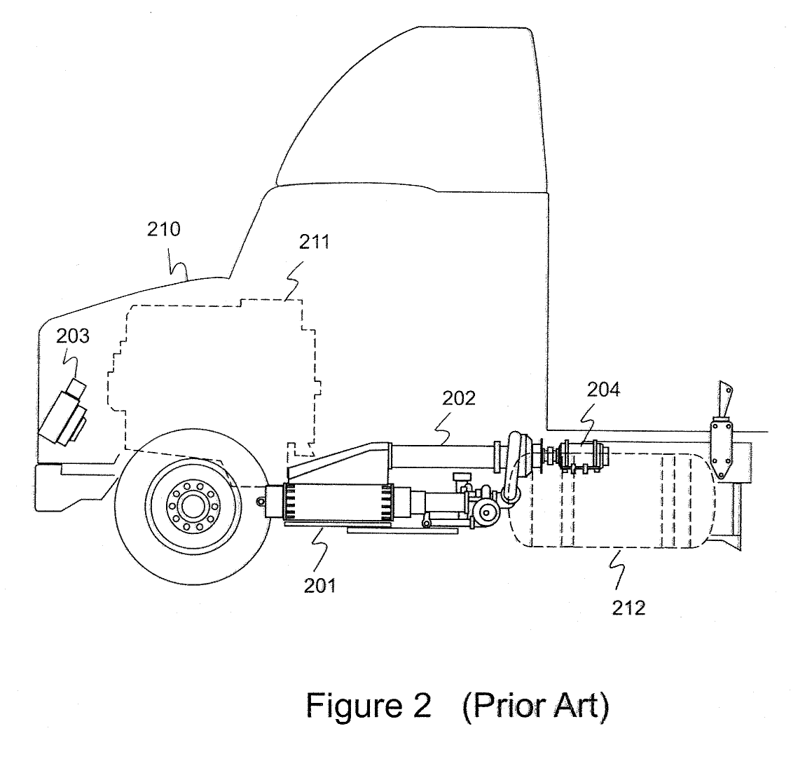

FIG. 2 is a line drawing of a gas turbine engine 201 along with the outline of a comparable power diesel engine 211 in a Class 8 truck cab 210. This is prior art. This figure shows a high-performance ˜375 kW gas turbine engine 201 mounted in a Class 8 truck chassis and, for comparison, a ˜375 kW diesel engine 211 (without transmission and emissions control equipment). An intercooler 203 which is associated with gas turbine engine 201 is also shown. Duct 202 is also item 184 of FIG. 1. The gas turbine engine is substantially smaller than the diesel engine and can be readily operated on a variety of fuels that the diesel engine cannot utilize. Diesel fuel tank 212 is also shown.

The gas turbine engine described in FIGS. 1 and 2 can be configured with either a conventional metallic combustor or a so-called thermal reactor. The thermal reactor offers a practical means of achieving the necessary thermodynamic conditions for a gas turbine thermal reactor which allow the unpressurized gaseous fuel and air to be introduced at the engine air inlet. This strategy of fuel introduction and mixing eliminates the typical gaseous fuel pressurization system and associated parasitic losses, cost and complexity. The thermal reactor is typically designed for use in a multistage intercooled compressor, a recuperator and a multistage turbine to achieve the requisite thermodynamic conditions for consistent combustion. The thermal reactor can be used with liquid fuels where, preferably, the fuel is introduced between the recuperator and the combustor. In the case of liquid fuels, much less energy and a smaller apparatus are normally required to pressurize the liquid fuel with its much lower compressibility for injection into the compressed air stream. Reduction in Fuel Complexity As noted previously, a gas turbine engine is a continuous combustion engine and does not require blending, additives or special techniques for ignition. Reciprocating engines require ignition in each cylinder thousands of times per second and therefore require additives and special techniques for ignition to achieve proper performance and control of emissions. Further, for reciprocating engines to achieve thermal efficiencies as high as the most advanced gas turbines engines, the peak combustion temperatures must be considerably higher than the relatively constant temperature in a continuous combustion gas turbine engine. Since comparable power reciprocating and gas turbine engines combust the same amount of fuel energy per unit time, the gas turbine engine will always operate at a substantially lower temperature than the peak temperature generated by combustion every cycle by a reciprocating engine. This means that reciprocating engines will produce higher levels of NOx than a gas turbine engine of comparable power since NOx production increases approximately exponentially with temperature. To meet current emissions requirements, reciprocating engines must continually improve the quality of combustion through improvements in one or more of cylinder design, fuel blending, fuel additives and fuel injection techniques.

Consider the complexity of gasolines and diesel fuels for example. Gasolines are complex mixtures of hydrocarbons. Various grades of gasolines are blended to promote high anti-knock quality, ease of starting, quick warm-up, low tendency to vapor-lock, and low engine deposits. The components used in blending gasoline can be used to produce light straight-run gasoline or isomerate, catalytic reformate, catalytically cracked gasoline, hydrocracked gasoline, polymer gasoline, alkylate, n-butane, and such additives as ETBE, TAME (tertiary amyl methyl ether), and ethanol may be used. Other additives, for example, antioxidants, metal de-activators, and anti-stall agents are included with the antiknock chemicals added. The quantity of antiknock agents added must be determined by making octane blending calculations.

Today, diesel fuel is now a complex blend of hydrocarbons with an even wider range of additives than gasoline. Important performance aspects brought about by additives such as lubricity additives have been included. Further compositional changes are required to ensure low exhaust emissions. The continued improvement of the diesel engine to an even more efficient and environmentally acceptable prime mover with complex mixture preparation systems, such as high-pressure common-rail injection, requires high-quality diesel fuels. New refinery technologies, synthetic fuels or components, new additives and to some extent fuel from biomass will help to further improve performance. To reduce carbon dioxide emissions, low concentrations of fatty acid methyl esters produced from biomass as diesel fuel components can be added. With the reduction in sulfur, anti-wear additives have been developed and added to protect fuel pumps and nozzles. The cetane number was raised to 51 in 2000 to reduce ignition delay, improve combustion and reduce exhaust emissions. Being liquids, cetane improvers such as ethyl hexyl nitrates (EHN) are used to improve ignition performance. An important group of additives are cold-flow improvers and wax anti-settling additives. Another type of additive is detergents, which keep injector nozzles clean and help to keep exhaust emissions from increasing over time. Anti-corrosion and anti-wear additives (so called lubricity additives) protect not only the engine but also the fuel distribution system. Anti-foam additives remain important as they reduce foaming when vehicle tanks are refilled at service stations, preventing spillage and overfill.

The need for blending and many of these fuel additives in both gasoline and diesel fuels can be reduced or eliminated for use in gas turbine engines since gas turbine engines can combust most fuels without special ignition additives and never achieve the high transient combustion temperatures where most NOX is produced. It is also noted that, aromatics such as benzene, toluene and xylene used as octane enhancers for gasoline, are known to be carcinogenic. These could be reduced or eliminated from fuels for use in a gas turbine engine.

### Multi-Fuel Truck Configurations

The multi-fuel configurations discussed below have the advantage of extending the range of operation of the vehicle and provide an opportunity for optimizing vehicle economics by providing a convenient choice of using lower cost fuels when these are available or operating on readily available fuels when the preferred fuel is not readily available. Remote monitoring of the vehicle can be utilized to optimize vehicle economics by dispatch from a central logistics office.

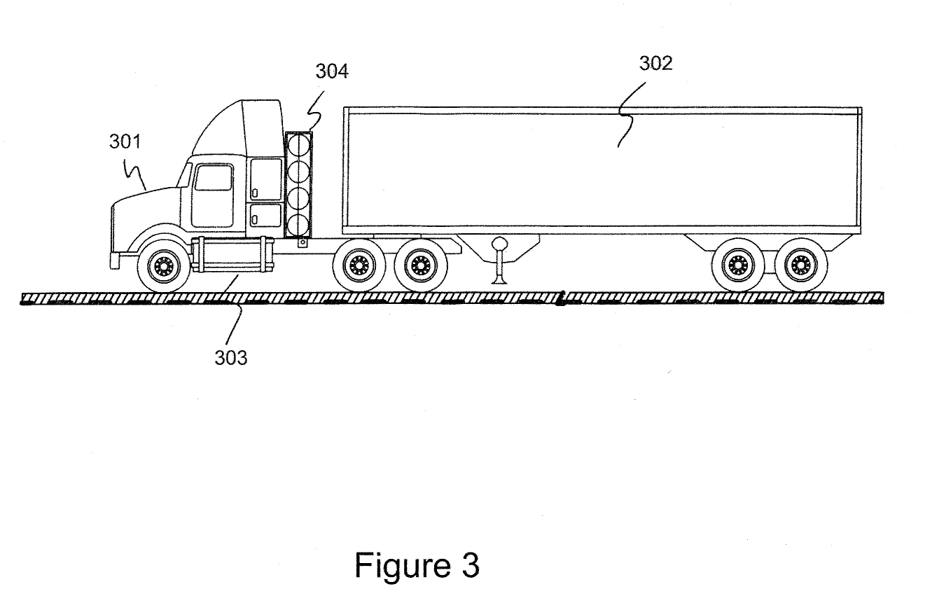

FIG. 3 is a schematic of a gas-turbine powered truck with a second fuel tank mounted behind the tractor cab. This figure shows a tractor 301 pulling a trailer 302. As an example, the tractor 301 is shown with diesel fuel tanks 303 mounted under the tractor cab. The diesel tanks can have a capacity in the range of about 150 to about 400 gallons of diesel fuel, with about 300 gallons of diesel fuel being typical. CNG tanks 304 are shown mounted behind the tractor cab. CNG tanks 304 are available commercially with capacity in the practical range of about 25 to about 150 DGEs with about 40 DGEs being required for about 250 miles of driving range.

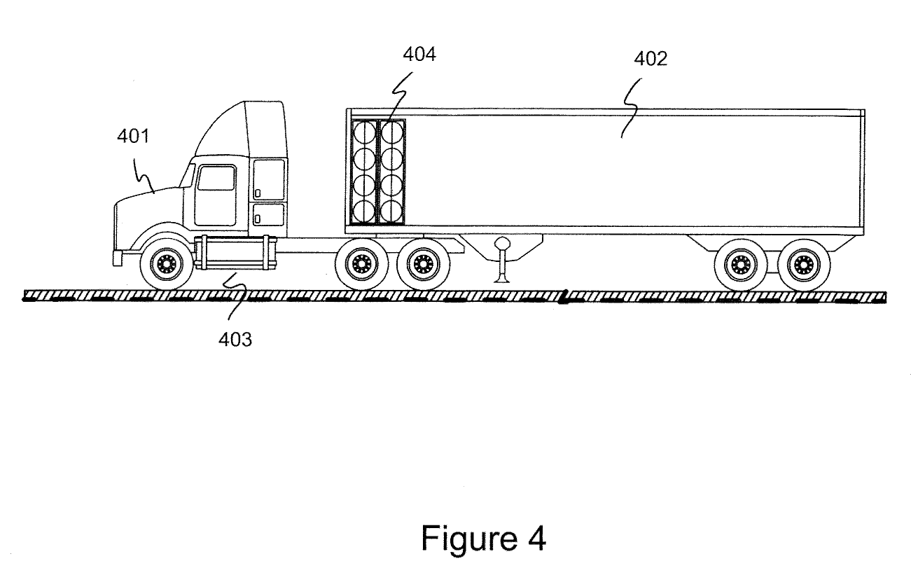

FIG. 4 is a schematic of a gas-turbine powered truck with a second fuel tank mounted inside the trailer. This figure shows a tractor 401 pulling a trailer 402. As an example, the tractor 401 is shown with diesel fuel tanks 403 mounted under the tractor cab. These tanks typically have a capacity similar to that set forth above, with about 300 gallons of diesel fuel being typical. CNG tanks 404 are shown mounted inside the trailer 402. CNG tanks 404 are available commercially with capacity in the practical range of about 25 to about 150 DGEs with about 40 DGEs being required for about 250 miles of driving range.

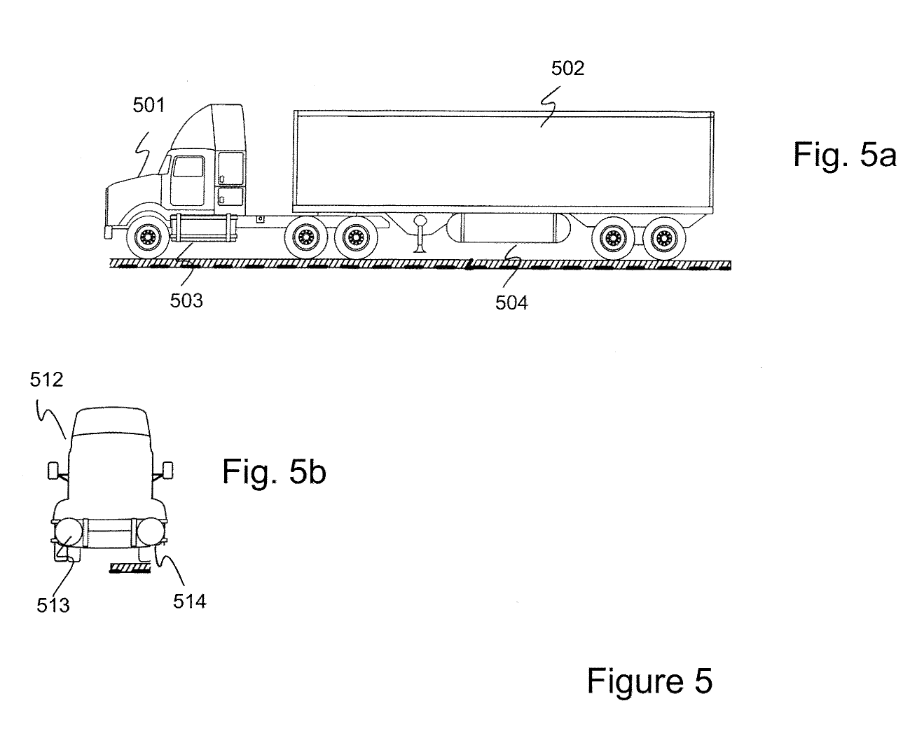

FIG. 5a is a schematic of a gas-turbine powered truck with a second fuel tank under the trailer. This figure shows a tractor 501 pulling a trailer 502. As an example, the tractor 501 is shown with diesel fuel tanks 503 mounted under the tractor cab. These tanks typically have a capacity similar to that set forth above, with about 300 gallons of diesel fuel being typical. CNG tanks 504 are shown mounted under the trailer 502. CNG tanks 504 are available commercially with capacity in the practical range of about 25 to about 150 DGEs with about 40 DGEs being required for about 250 miles of driving range.

FIG. 5b is a schematic of a gas-turbine powered truck showing fuel tanks 513 and 514 mounted under the tractor cab 512. Fuel tank 513 may contain a first fuel and fuel tank 514 may contain a second fuel. For example, fuel tank 513 may contain 100 to 200 gallons of liquid fuels such as diesel or gasoline or a mixture of both. Fuel tank 514 may contain 100 to 200 gallons of LNG or alternately fuel tank 514 may contain 25 to 50 DGE of CNG.

As can be appreciated, the above fuel tank configurations can include any combination of liquid and/or gaseous fuel tanks containing any combination of fuels that can be combusted in a gas turbine engine.

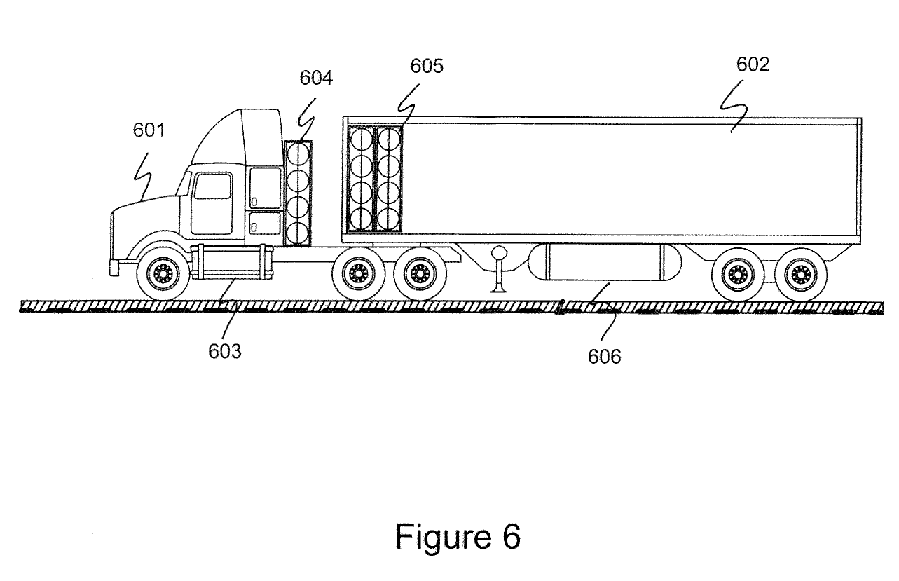

FIG. 6 is a schematic of a gas-turbine powered truck with several fuel tanks

This figure shows a tractor 601 pulling a trailer 602. As an example, the tractor 601 is shown with diesel fuel tanks 603 mounted under the tractor cab. These tanks typically have a capacity similar to that set forth above, with about 300 gallons of diesel fuel being typical. CNG tanks 604 are shown mounted behind the tractor cab. CNG tanks 604 are available commercially with capacity in the practical range of about 25 to about 150 DGEs with about 40 DGEs being required for about 250 miles of driving range. Hydrogen tanks 605 are shown mounted inside the trailer 602. Hydrogen tanks 605 are available commercially with capacity commonly in the range of about 10 to about 50 DGEs. Methanol tanks 606 are currently available commercially with capacity in the range of about 100 to about 500 DGEs.

In this example, the truck engine is a gas turbine engine that can burn any of diesel, natural gas, methanol or hydrogen fuels. When natural gas, methanol or hydrogen fuels are not available, the truck can be operated on diesel. If natural gas is available and is cheaper than diesel, then the truck would preferably be operated on natural gas. The truck can be operated on methanol if this fuel is available. The truck can include a reformer which can convert methanol into hydrogen and carbon dioxide, with the hydrogen being stored in tanks 605. The carbon dioxide can be stored in tanks (not shown) for disposal at a carbon dioxide disposal site. The truck can then be operated on hydrogen in areas where other fuels are restricted or prohibited because of greenhouse gas emission considerations.

### Multi-Fuel Fueling Station

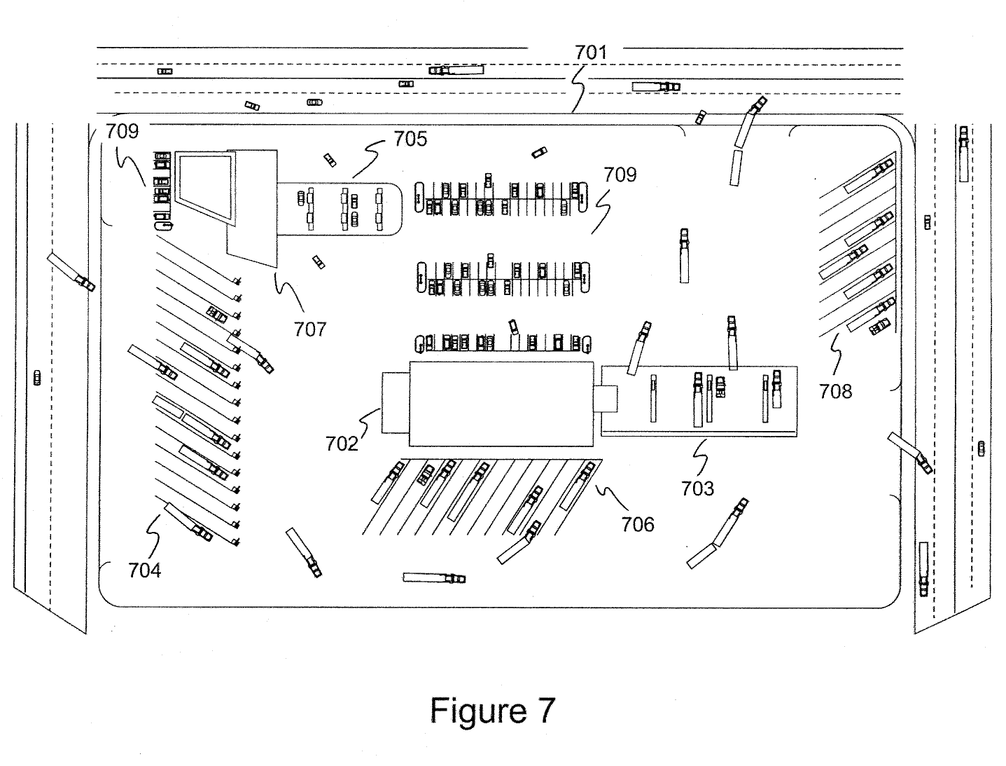

FIG. 7 is a schematic of an example multi-fuel fueling station. This figure shows a typical fueling station accessed from a main thoroughfare 701, such as for example an interstate highway or a connector to an interstate highway. The fueling station is comprised of a parts store/restaurant 702, a convenience store 707, several auto parking areas 709, several truck diesel pump dispensing lanes 703, several auto gasoline and diesel pump dispensing lanes 705, a truck parking area 706, an overnight truck electrification (TSE) truck parking area 708 and a truck parking area with several CNG fuel fill posts 704. Additionally there can be separate CNG and LNG dispensing lanes similar to the truck diesel pump dispensing lanes 703, dispensing natural gas. As can be further appreciated, there can be other fuel pump dispensing other liquid fuel like methanol, bio-diesel, and ethanol but unlike CNG would require supervised filling on a catchment surface of a fueling lane and not in a unpaved parking area.

In this example, a gas turbine powered truck with multi-fuel capability such as shown in FIGS. 3 through 6 can be refueled with either or both diesel and CNG. Diesel fuel can be pumped by the vehicle operator or a station attendant in the normal manner. In the case of CNG, CNG can be pumped by the vehicle operator or a station attendant using a high speed fueling system or the vehicle can be refueled by the vehicle operator who, after initiating refueling, goes to the store/restaurant while CNG tank is being refueled by a slower fueling system. The design of the dual fuel or multi-fuel fueling station is such that the vehicle operators perform fueling operations in the manner to which they are accustomed.

For CNG or other gaseous fuels, a slow fueling system can be practical. With this method, the vehicle remains in a parking space which is equipped with a CNG or another gaseous fuel dispensing system. The parking space may also include a TSE capability. The vehicle operator would initiate fueling and then leave the vehicle while he/she uses the restaurant/store facilities. The slow fueling system is preferred because it uses less energy and therefore would result in a fuel cost savings. With this method, the gaseous fuel is compressed from a low pressure line or storage tank to the final pressure in the vehicles fuel tank (typically in the range of about 3,600 psi to about 4,500 psi). The slow fueling method also allows the heat generated by compression to dissipate through the fuel tank walls.

The refueling facility can transmit fuel availability, price, facility availability. Upon selection of a fueling strategy by the driver and/or the computer, an ID tag and fuel station pump location can be transmitted to the on board computer that optimizes driver experience and minimizes wait times. The facility can update fuel port allocations in real time to reduce any delays. The vehicle ID number can be associated with the transaction number for fuel pump activation and the ensuing financial transaction. The fuel pump can only permit fueling when the vehicle ID and transaction number match for a specific delivery port at the refueling station. For heavy use periods premium lanes with no wait may be available for an increased fuel cost.

The refueling transaction can be either on a credit basis, taken from a prepaid account, or accumulated for separate invoicing but be substantially automated without additional driver input. Payment for fueling can be accomplished by several means, including but not limited to cash, credit card, debit card, automated license scanning and subsequent e-mailed or mailed billing and the like. If an emissions or greenhouse credit is available, this credit can also be accounted by any number of well-known means.

The energy to compress a kilogram of natural gas to about 3,600 psi with a slow fueling system is approximately 1.3 MJ. The energy to compress a kilogram of natural gas to about 3,600 psi with a fast fueling system is about 1.6 MJ or about 23% more energy than with a slow fueling system .

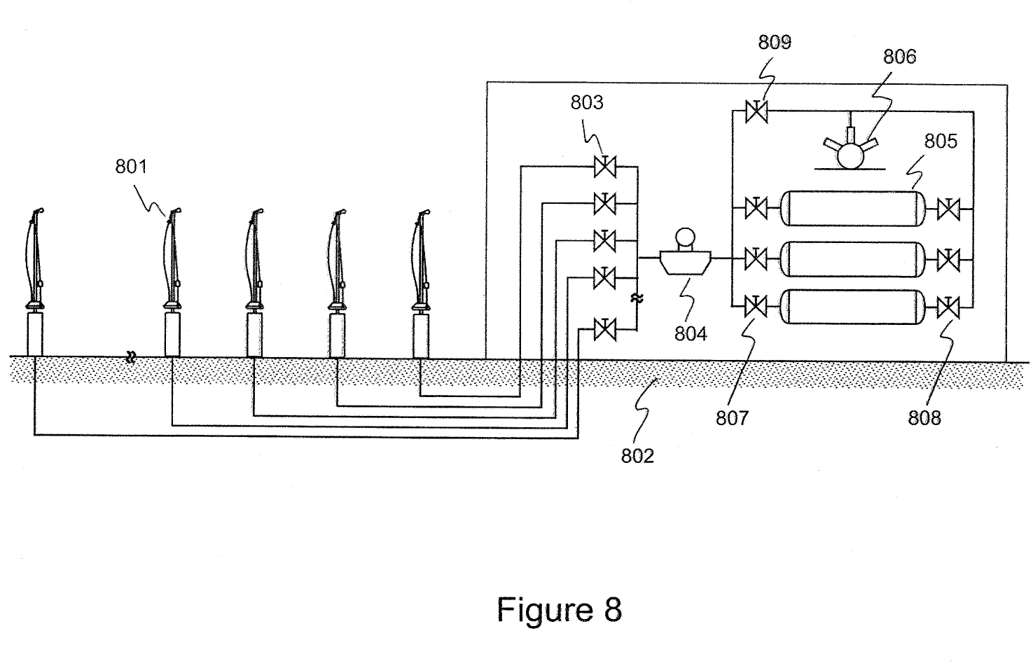

FIG. 8 is a schematic of a CNG fuel dispensing system such as may be included in the truck stop of FIG. 7. This figure shows several fuel filling posts 801 at which large trucks can re-fuel their CNG tanks Fueling a 20 to 50 DGE CNG tank is expected to take from about 15 to about 30 minutes, depending on how much fuel is required by each truck and how many trucks are being fueled at the same time. CNG is typically stored in three CNG storage tanks 805 in a cascaded storage arrangement. CNG is dispensed to multiple filling posts 810 using a single flow meter 804. Valves 803 control metered amounts of CNG to the various filling posts. Valves 807 control which storage tank 805 provides the CNG. The storage tanks are typically maintained at differing pressures so that initial filling is done at the lowest pressure and final topping off is done at the highest pressure. This cascaded fill approach minimizes energy required to fill a vehicle CNG fuel tank. Compressor 806 controls the pressure in tanks 805 via sequencing valves 808 when valve 809 is open. All valves and flow meter 804 are electronically controlled so that the amount of CNG dispensed at each filling post is precisely known. This configuration eliminates the need for a separate expensive flow meter at each filling post 801. Flow meter 804 can dispense CNG at a rate in the range of about 5 DGE per minute to about 100 DGE per minute, depending on the number of CNG filling posts 801. It is noted that the CNG fueling area may be paved or unpaved as there is no ground spillage from a CNG fuel dispensing facility. As can be appreciated, this dispensing system can be used for any fuel whether it is gaseous or liquid. The principal innovation is the use of a single flow meter to dispense fuel to multiple fueling stations. All the valves, the single flow meter and storage tanks can be contained in a single nearby or remote location with an underground natural gas line routed to the area of the various gas filling posts.

### Economics of Multi-Fuel Vehicles

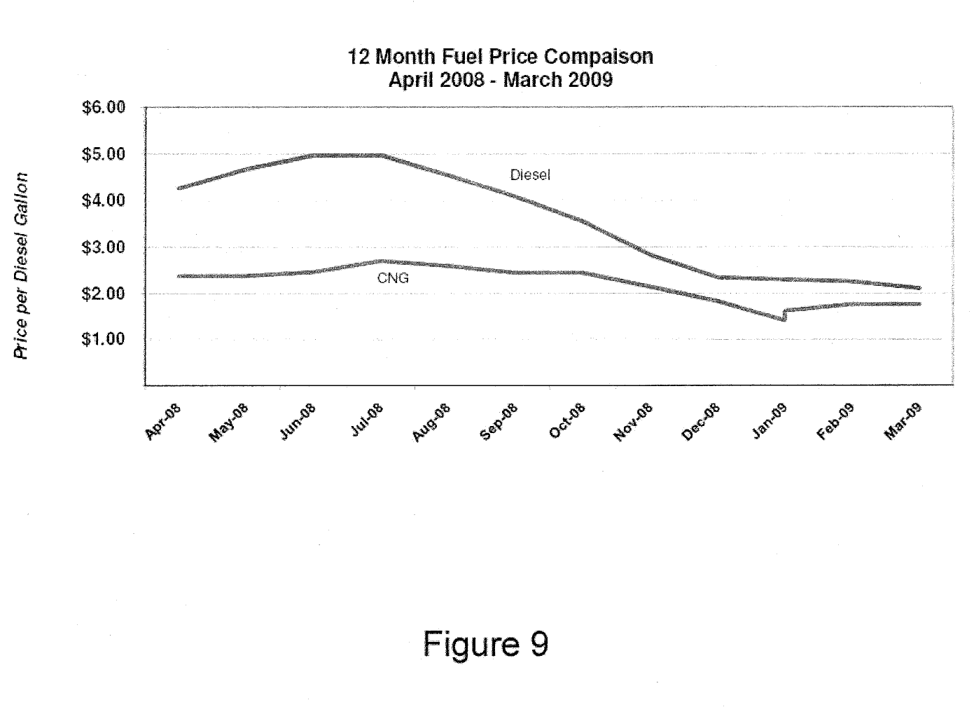

As can be appreciated, the price of fuels can vary over time as well as with the type of fueling station. FIG. 9 shows typical annual price variation of diesel and compressed natural gas fuels. In recent years, the price of compressed natural gas has been less than that of diesel when compared on a specific energy basis. The price of compressed natural gas is expressed in Diesel Gallon Equivalents (DGEs) where a DGE of natural gas delivers the same energy as a gallon of diesel on a low heat value (LHV) basis. For the early part of the year from April 2008 to March 2009, the price of diesel was roughly twice that of CNG. For the latter part of the year, the price of diesel was only slightly higher than that of CNG. As can be appreciated the price of diesel can, at times, be lower than the price of CNG.

Another advantage of multi-fuel capability is that the risk from severe price spikes due to temporary supply and demand issues with a particular fuel can be mitigated or eliminated.

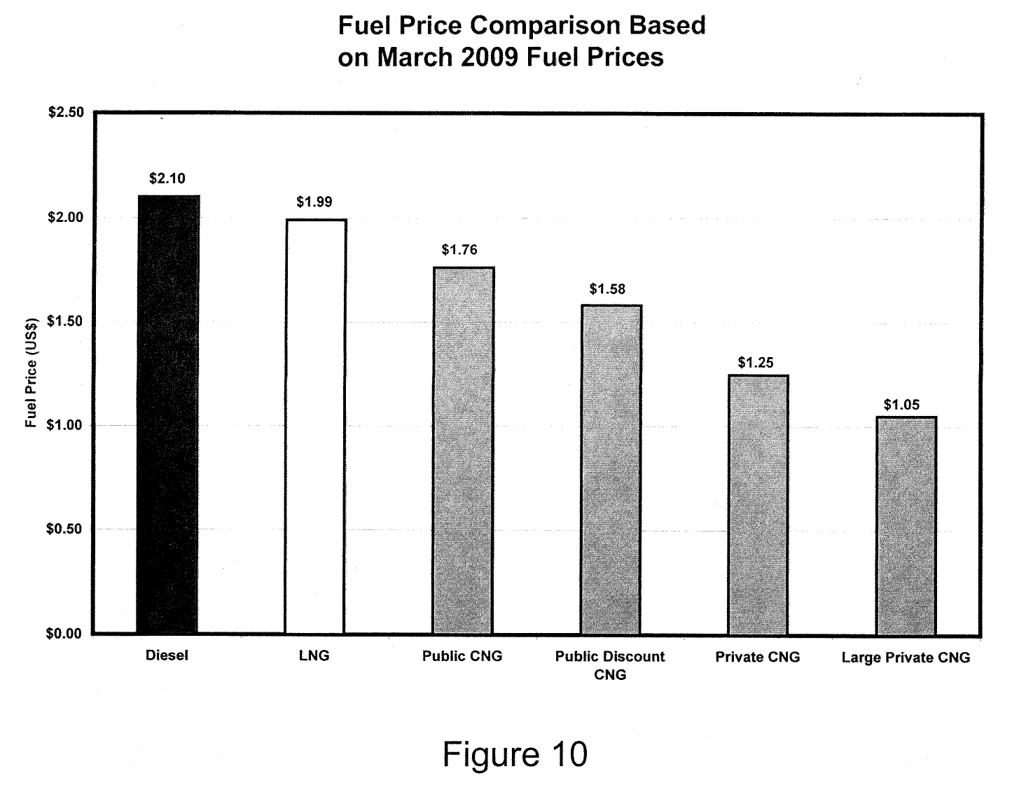

FIG. 10 shows typical variation of price as a function of station size. This shows the price of diesel and natural gas as a function of fueling station type and size for March 2009 when the price of diesel was roughly twice that of CNG. At this time, the price of LNG was somewhat less than the price of diesel while the price of CNG purchased at a large private fueling station was roughly half the price of diesel. It is noted that the cost and price of CNG is almost always lower than the cost and price of LNG.

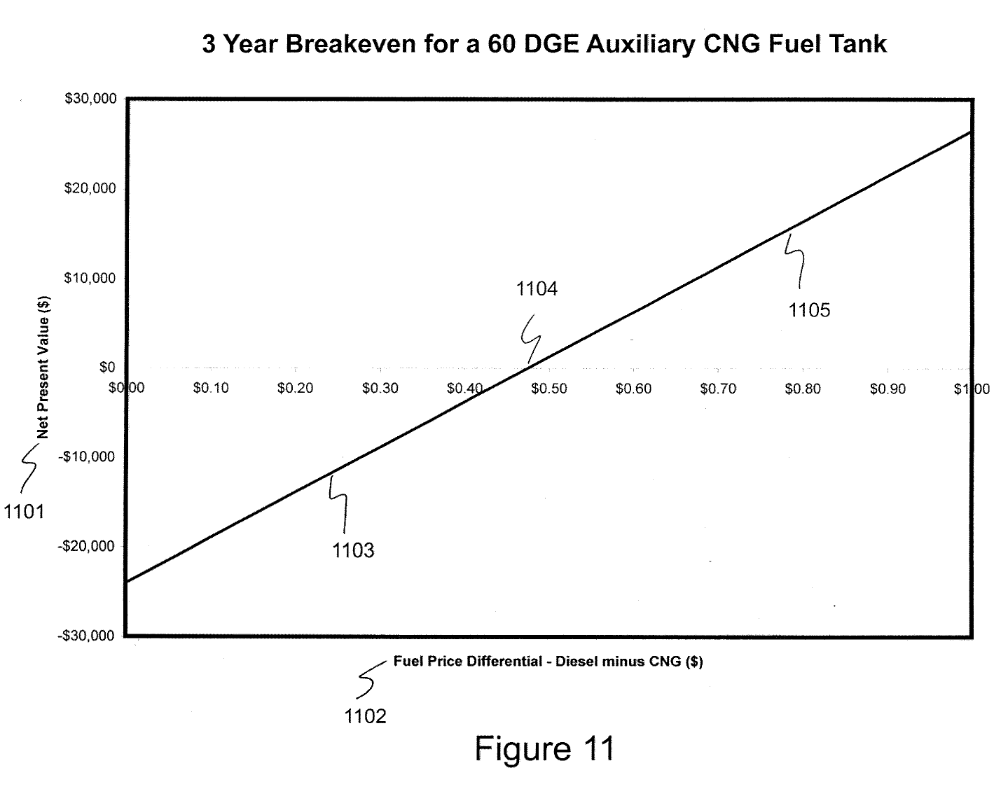

FIG. 11 shows breakeven cost for use of a lower price alternate fuel. This figure illustrates an example of a Class 8 long-haul truck capable of operating on either diesel or CNG fuel. The diesel tank capacity is 300 gallons and the auxiliary CNG tanks have a capacity of 60 DGEs. Under reasonable driving assumptions, the analysis evaluates the price spread required between diesel and CNG (when CNG is less expensive than diesel) to recover the capital cost of the CNG tanks in 3 years. When a DGE of CNG is 48 cents less than the price of a gallon of diesel in this example, breakeven occurs in 3 years. When the price differential of a DGE of CNG is greater than 48 cents compared to the price of a gallon of diesel, there is a net profit realized from using CNG in less than 3 years. Alternately, when the price differential of a DGE of CNG is less than 48 cents compared to the price of a gallon of diesel, it will take longer than 3 years to breakeven.

This analysis shows how a multi-fuel strategy can be developed based on projections of fuel costs and/or fuel consumption. If diesel fuel is less expensive than CNG, for example, then the auxiliary tanks can be removed from the truck to save weight. If diesel fuel is more expensive than CNG, then the truck can be operated as much as possible on CNG. If CNG is not available, then the truck can be operated on diesel. In any of these situations, the vehicle operator is not bound by the auxiliary fuel infrastructure. However, as the fuel infrastructure grows, the vehicle operator can take more frequent advantage of the lower cost fuel.

### Optimizing Fuel Usage and Driving Strategy

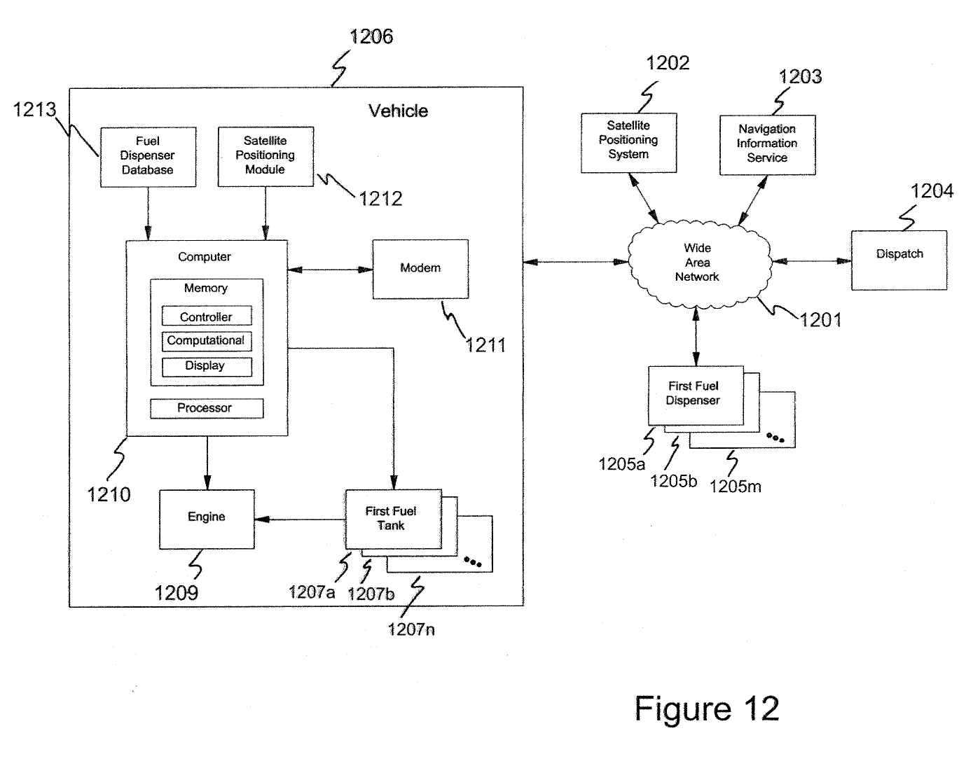

FIG. 12 is a schematic representation of a network-based system for optimizing fuel consumption and driving strategy for a multi-fuel vehicle. With a multi-fuel vehicle of the present invention, the operator always has the option of running on a widely available fuel such as diesel or gasoline which has a well-developed fuel dispensing infrastructure and to which the operator is accustomed. However, the operator has an opportunity to substantially reduce vehicle operating costs and/or fuel consumption by utilizing a Wide Area Network (WAN), such as the Internet, to optimize fuel costs, fuel consumption and driving schedule, especially with a vehicle that can operate on more than one fuel. This opportunity arises because of 1) the ability of a gas turbine engine to readily burn multiple fuels or combinations of multiple fuels and 2) the ability of the operator to switch fuels on the fly (while driving). This first ability, in turn, arises because the gas turbine engine burns fuels continuously based on their energy content, not cyclically based on their ignition characteristics as is the case with reciprocating engines such as diesel engines.

As shown in FIG. 12, the system includes a vehicle 1206, a satellite positioning system 1202, a navigation information service 1203, an optional dispatch capability 1204 and a first, second, and up to an m-th fuel dispenser 1205a, 1205b, . . . 1205m, all interconnected by a Wide Area Network (WAN) 1201.

Vehicle 1206 includes a computer 1210, a modem 1211, a fuel dispenser database 1213, a satellite positioning module 1212, an engine 1209 and a first, second, and up to an n-th fuel tank 1207a, 1207b, . . . 1207n in signal communication, via duplexed channels, with computer 1210.

The engine 1209 and fuel tanks 1207a through 1207n are apparatuses having an operation or feature controlled by computer 1210. Computer 1210 includes a memory module and a processor module. The computer 1210 is preferably a software-controlled device that includes a number of modules in memory executable by the processor.

The executable modules include a controller to receive and process status signals from the engine and fuel tanks and to generate and transmit appropriate commands to the monitored engine and fuel tanks The executable modules also include a computational module to receive and process status signals from the engine, fuel tanks, satellite positioning module, user or operator interface (which may be touchscreen, keyboard, switch, computer, or other type of interface), fuel dispenser database and WAN and which computes fuel and fueling recommendations and recommended driving strategies to optimize fuel and other operational costs. The executable modules also include a video display module (which may be part of the user or operator interface) that allows the vehicle operator to view the recommended fuel, fueling and driving strategies and to select none, some or all of the recommendations or alternately to instruct the computer to automatically select some or all of the recommendations.

In one configuration, the executable modules include a fuel monitoring module that receives the identities and monitors the remaining amounts of the fuels or fuel mixtures in each of the first, second, . . . n-th fuel tanks 1207a-n. The fuel monitoring module can receive the identities of the fuels or fuel mixtures by any suitable technique, such as by user or operator input via the user or operator interface, wireless communication (by a suitable wireless data transmission protocol such as by Bluetooth) from the fuel provider, a sensor or reader in signal communication with an identification tag (such as RFID tag, bar code, and the like) associated with the particular fuel dispenser dispensing fuel into the corresponding fuel tank, Internet transmission via WAN 1202 from the fuel provider, and the like.

In one configuration, the executable modules include a fuel dispenser module to select a particular fuel type and/or mixture from one or more fuel tanks and configure the engine and/or engine sub-component, particularly a gas turbine or fuel injection system, to dispense and combust the fuel. This normally requires one or more engine and/or engine sub-component settings to be changed from a first setting associated with a first fuel and/or fuel mixture to a second setting associated with a second fuel and/or fuel mixture. This can be done, for example, using a lookup table in the fuel dispenser database or an appropriate algorithm. In the context of a gas turbine, the change of fuels and/or fuel mixtures typically requires a change in the injection system and/or injected fuel/air mixture.

The fuel dispensers 1205a through 1205m are fuel providers, such as a privately or publically owned fueling stations, that are operable to dispense various fuels. Fuel dispensers 1205a through 1205m also have network sites which provide information on fuels, including price, availability and subsidy (if available) information. The systems are operable to provide, via WAN 1202, fuel dispenser information to any vehicle 1206 which is connected to the WAN and which has on-board capability to receive and process this information. The fuel dispenser platforms can be any processor-based system, such as a mainframe, personal computer, cell-phone, laptop or notebook computer.

The satellite positioning system 1202, navigation information service 1203 (which may also include information on current road and weather conditions) and fuel dispensers 1205a through 1205m sense and collect parameters regarding fueling locations, directions to these locations, available fuel types and specifications, fuel prices and availability as well as any applicable subsidy information via the WAN 1201. The sensed parameters also include additional information such as, for example, fuel ignition characteristics and fuel energy content and the like.

The vehicle includes a number of sub-components. An on-board computer has a memory and processor. Included in the memory are several modules such as a controller, a computational module, and a display module. Computer 1210 also has access to a fuel dispenser database 1213 which stores past information received from fuel dispensers via WAN 1201 or other sources as well as storing current information received from fuel dispensers via WAN 1201 or other sources. As will be appreciated, the database and memory can be any suitable non-transitory computer readable medium.

In operation, on-board computer 1210 has access to the vehicle's current location from on-board satellite positioning module 1212. The on-board satellite positioning module 1212 may be a stand alone unit, a part of a cell phone or a part of a portable computer connected to the on-board computer 1210. Computer 1210 also has the ability to select from any one of a number of fuels 1207a through 1207n carried on-board the vehicle and to switch the vehicle's engine 1209 to operate on a selected fuel. The selection of the fuel or fuel mixture is determined by the particular fuel strategy, which can depend on a number of factors, including desired emission characteristics (which can be dependent on the physical location of the vehicle 1206), fuel availability (on board the vehicle and/or in spatial proximity to the vehicle), fuel cost and/or fuel consumption, and the like. Desired emission characteristics, for example, can be stipulated by a governmental entity and can therefore vary by sensed physical location. A city or first state, for instance, can have a first set of emission requirements while a rural community or different second state has no or a less restrictive, second set of emission requirements. When the vehicle 1206 is in the city or first state, it consumes a, typically more expensive but emissions compliant fuel or fuel mixture, and, when the vehicle 1206 is in the rural community or second state, it consumes a less expensive and less emissions compliant fuel or fuel mixture.

The vehicle 1206 also includes an ability to automatically connect to and interact with WAN 1201 via modem 1211. WAN 1201 includes interconnections to satellite positioning system 1202 and a navigation information service 1203. Satellite positioning system 1202 and a navigation information service 1203 together provide the vehicle with information on its location and on all routes available to the vehicle on any selected map scale. WAN 1201 also includes interconnections to fuel dispensers 1205a through 1205m along the routes within at least several hours driving range of the vehicle. WAN 1201 optionally includes connection to the vehicle owner dispatch center 1204 if the vehicle is part of a fleet.

The controller module in computer 1210 continuously monitors the amount of each of the fuels on board as well as the current fuel in use and the current fuel consumption of engine 1209. In one configuration, the controller module further monitors the current (average, median, mode, lowest, and/or highest) price (which monitoring function can be limited to the prevailing price in the physical vicinity of the vehicle) of the various fuels in the first, second, . . . n-th fuel tanks The controller module also continuously monitors satellite positioning module 1211 to determine where the vehicle is currently located. The computational module receives information from the controller module and continuously calculates vehicle range for each fuel, the maximum range of the vehicle for all combinations of fuel and the driving distance and time to each of the fuel dispensers within driving range. The display module continuously displays this information on a video monitor accessible to the operator.

Concurrently, the controller module in computer 1210 continuously interrogates

WAN 1201 for fuel dispenser information obtained from fuel dispenser websites 1205a through 1205m. This information includes location of the fuel dispenser, availability and prices of the various fuels offered, the hours of business and any other pertinent information such as other products and amenities offered. The controller also continuously interrogates WAN 1201 for information on vehicle location by interrogating satellite positioning system 1202 and navigation information service 1203.

From this information, the computational module, in one configuration, estimates the best locations for the operator to obtain the fuels of interest based on fuel prices and the distance to the fuel dispenser, and the video module arranges this information for display on the operator's video monitor. This estimation can be done in many ways. In one technique, the computational module determines the amount of fuel needed to fill the particular fuel tank and, for that fuel, determines the total cost, for each fuel provider, to fill the tank. The module can also determine the fuel cost and/or fuel consumption to drive to that fuel provider. A total cost (including both the fuel cost to fill the particular fuel tank and fuel cost and/or fuel consumption to drive to that fuel provider (using in the latter calculation a current or historic fuel cost) can be determined for each fuel provider. The fuel provider having the lowest total cost would be the first recommendation, the fuel provider having the next lowest total cost the second, and so on. This computation can be done for each type of on board fuel or a subset of the fuels. In the former case, the total cost for each provider would be based on the total fuel costs to fill each fuel tank plus the fuel cost and/or fuel consumption to drive to the provider. Other algorithms may be employed as will be appreciated by one of ordinary skill in the art.

In one configuration, the computational module selects and implements an appropriate fuel strategy. The fuel strategy can be based, for example, on proximity to a particular type of fuel provider, emission requirement, on board relative fuel costs and/or fuel consumption of the fuels in the various fuel tanks, characteristics of to driving route and the like.

In one configuration, the operator can then select the best, or recommended, option for refueling or the operator can instruct computer 1210 to automatically select the best option for refueling. If the vehicle is part of a fleet, computer 1210 can communicate the collected information and recommended options via WAN 1201 to the fleet dispatcher 1204 for further advice and consent.

In one configuration, the computational module selects and recommends to the operator a particular fuel strategy or the operator can instruct the computer 1210 to automatically select the best fuel strategy. implements an appropriate fuel strategy. If the vehicle is part of a fleet, computer 1210 can communicate the collected information and recommended fuel strategy via WAN 1201 to the fleet dispatcher 1204 for further advice and consent.

The on board logic may also have a built in payment capability to handle credit card payments, prepaid amounts, or it may just capture expenditures. This will reduce the actions required by the driver at the truck stop. Additionally, the fuel dispenser may be configured to send out a message to the drivers cell phone when fueling is completed or about to be completed. Other information can be incorporated such as maintenance, efficiency, payload for ton-mile calculations. Built in load cells for calculation might become a necessity for new efficiency legislation. The data collected could provide a detailed report that would allow monitoring of key metrics.

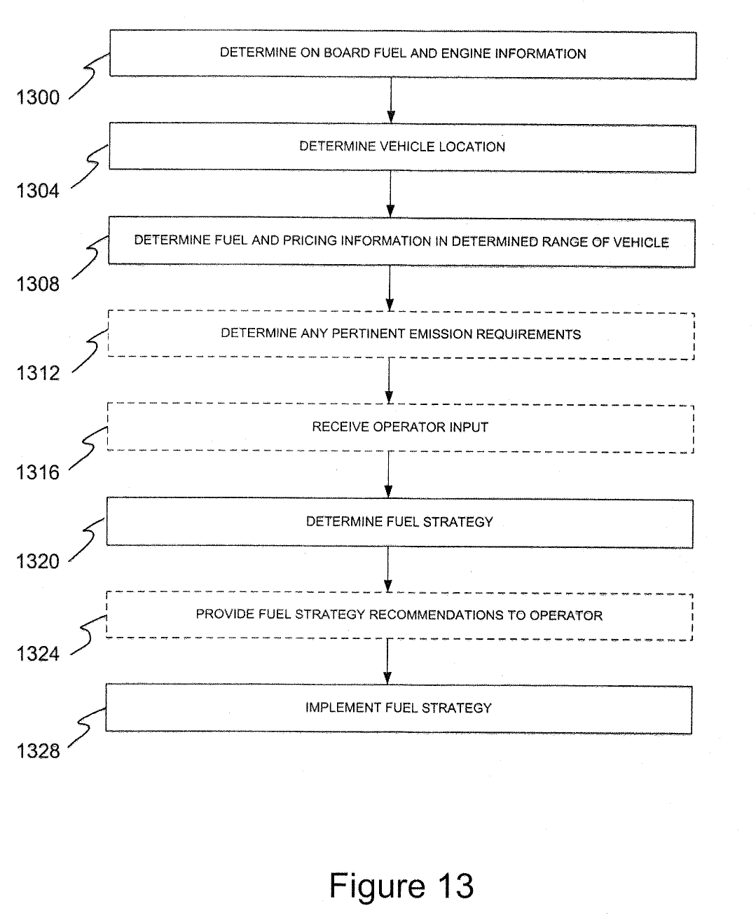

An operational embodiment of the system of FIG. 12 will now be described with reference to FIG. 13. In step 1300, the computer 1210 (e.g., using various executable modules including the fuel monitoring module, computational module, and/or controller module) determines current on board fuel and engine information. Fuel information includes, for example, the type and amount of fuel in each first, second, . . . n-th fuel tank 1207a-n, which fuel(s) is/are currently being fed into the engine 1209, and the current fuel consumption rate (based on a measure of miles traveled (e.g., miles/gallon), time (e.g., gallons/hour), and the like), and current injection fuel mixture (e.g., fuel type and fuel/air ratio) being fed to the engine 1209. Engine information includes, for example, current engine temperature, current engine air and fuel flow rates, current engine oil pressure, current vehicle velocity and/or acceleration, current engine power output, and the like).

In step 1304, the computer 1210 (e.g., using the satellite positioning module and/or computational module) determines the current vehicle location. Vehicle location is commonly relative to a coordinate system, such as the Global Positioning System.

In step 1308, the computer 1210 (accessing the fuel dispenser database 1213 and/or using the computational module and/or controller module) determines, by on-board fuel type, fuel and pricing information within a determined range of the vehicle. Fuel and pricing information includes, for example, current (average, median, mode, lowest, and/or highest) price, identity and location of each first, second, . . . m-th fuel dispenser 1205a-m, hours of business and products and amenities offered of each first, second, . . . m-th fuel dispenser 1205a-m, for each fuel dispenser the available fuel types and fuel replacement cost (e.g., the cost to fill the corresponding first, second, . . . nth fuel tank 1207a-n, which can include the fuel cost to drive from the current vehicle location to the fuel dispenser), directions from the current vehicle location to each first, second, . . . m-th fuel dispenser 1205a-m, link to web page of each first, second, . . . m-th fuel dispenser 1205a-m, and the like.

In optional step 1312, the computer 1210 determines, based on the current physical location of the vehicle and using a lookup table, any pertinent emissions requirements or regulations to be complied with by the vehicle. The lookup table may express the emissions requirements in terms of the fuel injection mixture to be employed.

In optional step 1316, the computer 1210 determines any operator input received regarding the fuel strategy or information desired. Input can include, for example, operator preferences and configuration commands, requests for specific type of information or other output from the computer 1210, and the like.

In step 1320, the computer 1210 (using the controller module, computational module, and/or fuel dispenser module) determines an appropriate fuel strategy to be implemented and/or presented to the operator for his or her consideration. The fuel strategy, as noted above, can be a recommendation of a refueling location, a particular fuel type and/or fuel mixture to be employed (in response to fuel type availability and/or unavailability, emission requirements, fuel costs, and the like).

In optional step 1324, the selected or determined fuel strategy is presented to the operator, by the user interface and/or video display module. The operator, in response, can select or approve a recommended strategy.

In step 1328, the fuel strategy is implemented by the computer 1210 (using the controller module and/or fuel dispenser module). As noted, implementation includes selecting a particular fuel type and/or fuel mixture and configuring the engine and/or an engine sub-component to dispense and combust the fuel.

As will be appreciated, the above steps can be performed in any order or sequence.

The system disclosed in FIGS. 12 and 13 allow the operator of the vehicle, or the fleet manager if the vehicle is a member of a fleet, to optimize operational costs and/or fuel consumption by estimating the best combination of fuels, fuel dispensers and driving and/or fuel strategies. By carrying at least one readily available fuel (such as diesel or gasoline), the operator is free of infrastructure shortcomings for other fuels that may be less expensive or have desirable emission characteristics. With the assistance of the system of FIG. 12, the vehicle operator can therefore efficiently manage the use of on-board fuels as well as efficiently manage his driving schedule and route to continue to get the best fuels at the best available prices.

A number of variations and modifications of the inventions can be used. As will be appreciated, it would be possible to provide for some features of the inventions without providing others.

The present invention, in various embodiments, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, for example for improving performance, achieving ease and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
(a) determining, by a computer, a current spatial location of a vehicle, the vehicle having at least differing first and second fuels for a common engine of the vehicle;
(b) determining, by the computer, at least one of fuel availability, fuel pricing information and routing information for one or more fuel dispensers within a determined range of the vehicle; and
(c) based on the determined at least one of fuel availability, fuel pricing information and routing information, determining, by the computer, a fuel strategy involving at least one of the first and second fuels.

2. The method of claim 1, wherein the current location is received from a satellite positioning system and further comprising:
(d) determining at least one of current fuel and engine information for the vehicle, wherein the fuel strategy is based on the determined at least one of current fuel and engine information for the vehicle.

3. The method of claim 2, wherein the at least one of current fuel and engine information is current fuel information and comprises a type and amount of fuel in each of first and second fuel tanks of the vehicle, which of the first and second fuels are currently being fed into the engine of the vehicle, a current fuel consumption rate of the engine, and a current injection fuel mixture being fed to the engine.

4. The method of claim 2, wherein the at least one of current fuel and engine information is current engine information and comprises current engine temperature, current engine fuel/air ratio, current engine oil pressure, current vehicle velocity and/or acceleration, and current engine power output.

5. The method of claim 1, wherein the at least one of fuel and pricing information for one or more fuel dispensers comprises one or more of current price for one or more fuels offered by each one or more fuel dispensers, identity and/or location of each one or more fuel dispensers, hours of business and/or products and/or amenities offered by each one or more fuel dispensers, for each one or more fuel dispenser available fuel types and/or fuel replacement cost, directions from the current vehicle location to each one or more fuel dispensers, and a respective link to a web page of each one or more fuel dispensers.

6. The method of claim 1, wherein the determined fuel strategy is based in part on an applicable emission requirement.

7. The method of claim 1, wherein the determined fuel strategy comprises one or more of the following:
(i) which of the first and second fuels will be combusted by the engine;
(ii) a fuel/air ratio to be combusted by the engine;
(iii) a mixture of the first and second fuels to be combusted by the engine;
(iv) an engine setting for the engine;
(v) an identity and/or location of a fuel dispenser to be used by the operator;
(vi) a fuel specific energy content; and
(vii) a fuel ignition characteristic to be employed.

8. The method of claim 1, further comprising:
implementing the determined fuel strategy, wherein implementing requires changing a fuel type and/or mixture being provided to the engine.

9. A non-transitory computer readable medium comprising instructions that, when executed, perform the steps of claim 1.

10. A system, comprising:
a computer operable to:
(a) determine a current spatial location of a vehicle, the vehicle having at least differing first and second fuels for a common engine of the vehicle;
(b) determine at least one of fuel and pricing information for one or more fuel dispensers within a determined range of the vehicle; and
(c) based on the determined at least one of fuel and pricing information, determine a fuel strategy involving at least one of the first and second fuels.

11. The system of claim 10, wherein the current location is received from a satellite positioning system and wherein the computer is further operable to:
(d) determine at least one of current fuel and engine information for the vehicle, wherein the fuel strategy is based on the determined at least one of current fuel and engine information for the vehicle.

12. The system of claim 11, wherein the at least one of current fuel and engine information is current fuel information and comprises a type and amount of fuel in each of first and second fuel tanks of the vehicle, which of the first and second fuels are currently being fed into the engine of the vehicle, a current fuel consumption rate of the engine, and a current injection fuel mixture being fed to the engine.

13. The system of claim 11, wherein the at least one of current fuel and engine information is current engine information and comprises current engine temperature, current engine fuel/air ratio, current engine oil pressure, current vehicle velocity and/or acceleration, and current engine power output.

14. The system of claim 10, wherein the at least one of fuel and pricing information for one or more fuel dispensers comprises one or more of current price for one or more fuels offered by each one or more fuel dispensers, identity and/or location of each one or more fuel dispensers, hours of business and/or products and/or amenities offered by each one or more fuel dispensers, for each one or more fuel dispenser available fuel types and/or fuel replacement cost, directions from the current vehicle location to each one or more fuel dispensers, and a respective link to a web page of each one or more fuel dispensers.

15. The system of claim 10, wherein the determined fuel strategy is based in part on an applicable emission requirement.

16. The system of claim 10, wherein the determined fuel strategy comprises one or more of the following:
which of the first and second fuels will be combusted by the engine;
a fuel/air ratio to be combusted by the engine;
a mixture of the first and second fuels to be combusted by the engine;
an engine setting for the engine;
an identity and/or location of a fuel dispenser to be used by the operator; and
a fuel specific energy content to be employed.

17. The system of claim 10, further comprising:
implementing the determined fuel strategy, wherein implementing requires changing a fuel type and/or mixture being provided to the engine.

18. A method, comprising:
(a) determining, by a computer, a current spatial location of a vehicle comprising a fuel;
(b) determining, by the computer, a plurality of fuel dispensers within a determined range of the current vehicle location;
(c) for each fuel dispenser, determining, by the computer, at least one of a price for the fuel, a fuel consumption, and a cost to drive to the respective fuel dispenser from the current vehicle location; and
(d) presenting, by a computer and to the operator, at least one of the fuel price, the fuel consumption, the driving cost, a recommendation of a fuel dispenser of the plurality of fuel dispensers, and a ranking of at least some of the plurality of fuel dispensers.

19. The method of claim 18, wherein the determining step (a) comprises receiving the current spatial location from a satellite positioning system.

20. The method of claim 18, wherein the at least one of a price for the fuel and a cost to drive to the respective fuel dispenser from the current vehicle location in step (c) is the fuel price.

21. The method of claim 18, wherein the at least one of a price for the fuel and a cost to drive to the respective fuel dispenser from the current vehicle location in step (c) is the cost.

22. The method of claim 18, wherein the at least one of the fuel price, driving cost, a recommendation of a fuel dispenser of the plurality of fuel dispensers, and a ranking of at least some of the plurality of fuel dispensers is fuel price.

23. The method of claim 18, wherein the at least one of the fuel price, driving cost, a recommendation of a fuel dispenser of the plurality of fuel dispensers, and a ranking of at least some of the plurality of fuel dispensers is driving cost.

24. The method of claim 18, wherein the at least one of the fuel price, driving cost, a recommendation of a fuel dispenser of the plurality of fuel dispensers, and a ranking of at least some of the plurality of fuel dispensers is the recommendation.

25. The method of claim 18, wherein the at least one of the fuel price, driving cost, a recommendation of a fuel dispenser of the plurality of fuel dispensers, and a ranking of at least some of the plurality of fuel dispensers is the ranking

26. A vehicle, comprising:
a first fuel in a first fuel tank, the first fuel having an octane rating ranging from about 60 to about 120;
a first fuel in a first fuel tank, the first fuel having a specific energy, expressed as a low heat value, ranging from about 10 million joules per kilogram to about 60 million joules per kilogram;
a second fuel in a second fuel tank, the second fuel having a cetane number from about 10 to about 100;
a second fuel in a second fuel tank, the second fuel having a specific energy, expressed as a low heat value, ranging from about 10 million joules per kilogram to about 60 million joules per kilogram;
one of a turbine and microturbine engine; and
a fuel injection system operable to provide selectively to the engine the first fuel in the substantial absence of the second fuel, the second fuel in the substantial absence of the first fuel, and a mixture of the first and second fuels.

27. The vehicle of claim 26, wherein the first and second fuels are each substantially free of octane enhancers and cetane improvers.

28. The vehicle of claim 26, wherein the first and second fuels primarily include a hydrocarbon other than propane and methane.

29. A vehicle, comprising:
a first fuel in a first fuel tank;
a second fuel in a second fuel tank, the first and second fuels having differing compositions;
one of a turbine and microturbine engine; and
a fuel injection system operable to provide selectively to the engine the first fuel in the substantial absence of the second fuel, the second fuel in the substantial absence of the first fuel, and a mixture of the first and second fuels, wherein at least one of the following is true:
(a) a volume of the second fuel tank to the volume of the first fuel tank is in the range of from about 0.3:1 to about 1:1; and
(b) an available fuel energy of the first fuel in the first fuel tank to the second fuel in the second fuel tank is in the range of from about 2.5:1 to about 10:1.

30. The vehicle of claim 29, wherein (a) is true.

31. The vehicle of claim 29, wherein (b) is true.

32. The vehicle of claim 29, wherein the first fuel is at least one of diesel fuel, gasoline and LNG and the second fuel is at least one of CNG, propane, butane and hydrogen.

33. A method, comprising:
(a) providing a vehicle, the vehicle carrying first and second fuels, the first fuel being commonly available and the second fuel not being as commonly available as the first fuel and wherein a fuel injection system can provide selectively to a common engine at least one of a selected one of the first and second fuels and a selected combination of the first and second fuels;
(b) determining, by a processor-executable on-board satellite positioning module, a current spatial location of the vehicle;
(c) determining, by the processor, at least one of fuel and pricing information for one or more fuel dispensers within a determined range of the vehicle; and
(d) based on the determined at least one of fuel and pricing information, determining, by the processor, a fuel strategy involving at least one of the first and second fuels.

34. The method of claim 33, further comprising:
determining at least one of current fuel and engine information for the vehicle, wherein the fuel strategy is based on the determined at least one of current fuel and engine information for the vehicle.

35. The method of claim 34, wherein the at least one of current fuel and engine information is current fuel information and comprises a type and amount of fuel in each of first and second fuel tanks of the vehicle, which of the first and second fuels are currently being fed into the engine of the vehicle, a current fuel consumption rate of the engine, and a current injection fuel mixture being fed to the engine.

36. The method of claim 34, wherein the at least one of current fuel and engine information is current engine information and comprises current engine temperature, current engine revolutions per minute, current engine oil pressure, current vehicle velocity and/or acceleration, and current engine power output.

37. The method of claim 33, wherein the at least one of fuel and pricing information for one or more fuel dispensers comprises one or more of current price for one or more fuels offered by each one or more fuel dispensers, identity and/or location of each one or more fuel dispensers, hours of business and/or products and/or amenities offered by each one or more fuel dispensers, for each one or more fuel dispenser available fuel types and/or fuel replacement cost, directions from the current vehicle location to each one or more fuel dispensers, and a respective link to a web page of each one or more fuel dispensers.

38. The method of claim 33, wherein the determined fuel strategy is based in part on an applicable emission requirement.

39. The method of claim 33, wherein the determined fuel strategy comprises one or more of the following:
(i) which of the first and second fuels will be combusted by the engine;
(ii) a fuel/air ratio to be combusted by the engine;
(iii) a mixture of the first and second fuels to be combusted by the engine;
(iv) an engine setting for the engine;
(v) an identity and/or location of a fuel dispenser to be used by the operator;
(vi) a fuel specific energy content; and
(vii) a fuel ignition characteristic to be employed.

40. The method of claim 1, further comprising:
implementing the determined fuel strategy, wherein implementing requires changing a fuel type and/or mixture being provided to the engine.

41. A non-transitory computer readable medium comprising instructions that, when executed, perform the steps of claim 33.

42. A system, comprising:
a processor operable to:
determine a current spatial location of the vehicle, the vehicle comprising a commonly available first fuel and a less commonly available second fuel, a common engine, and a fuel injection system to provide selectively to the engine a selected one of the first and second fuels; and
a processor operable to:
determine at least one of fuel and pricing information for one or more fuel dispensers within a determined range of the vehicle; and
based on the determined at least one of fuel and pricing information, determine a fuel strategy involving at least one of the first and second fuels.

43. The system of claim 42, wherein the processor is further operable to determine at least one of current fuel and engine information for the vehicle, wherein the fuel strategy is based on the determined at least one of current fuel and engine information for the vehicle.

44. The method of claim 43, wherein the at least one of current fuel and engine information is current fuel information and comprises a type and amount of fuel in each of first and second fuel tanks of the vehicle, which of the first and second fuels are currently being fed into the engine of the vehicle, a current fuel consumption rate of the engine, and a current injection fuel mixture being fed to the engine.

45. The system of claim 43, wherein the at least one of current fuel and engine information is current engine information and comprises current engine temperature, current engine revolutions per minute, current engine oil pressure, current vehicle velocity and/or acceleration, and current engine power output.

46. The system of claim 42, wherein the at least one of fuel and pricing information for one or more fuel dispensers comprises one or more of current price for one or more fuels offered by each one or more fuel dispensers, identity and/or location of each one or more fuel dispensers, hours of business and/or products and/or amenities offered by each one or more fuel dispensers, for each one or more fuel dispenser available fuel types and/or fuel replacement cost, directions from the current vehicle location to each one or more fuel dispensers, and a respective link to a web page of each one or more fuel dispensers.

47. The system of claim 42, wherein the determined fuel strategy is based in part on an applicable emission requirement.

48. The system of claim 42, wherein the determined fuel strategy comprises one or more of the following:
which of the first and second fuels will be combusted by the engine;
a fuel/air ratio to be combusted by the engine;
a mixture of the first and second fuels to be combusted by the engine;
an engine setting for the engine;
an identity and/or location of a fuel dispenser to be used by the operator; and
a fuel specific energy content to be employed.

49. The system of claim 42, wherein the processor is further operable to:
implement the determined fuel strategy, wherein implementing requires changing a fuel type and/or mixture being provided to the engine.

50. A method, comprising:
providing a vehicle, the vehicle carrying first and second fuels, the first fuel being commonly available and the second fuel not being as commonly available as the first fuel and wherein a fuel injection system can provide selectively to a common engine at least one of a selected one of the first and second fuels and a selected combination of the first and second fuels without regard to the cetane number or octane rating of the first and second fuels or a selected combination of the first and second fuels.
